(19) United States
(12) Patent Application Publication
(10) Pub. No.: US 2025/0023451 A1
(43) Pub. Date: Jan. 16, 2025

(54) POWER SUPPLY CONTROLLER AND SWITCHING POWER SUPPLY

(71) Applicant: ROHM CO., LTD., Kyoto (JP)

(72) Inventor: Shun FUKUSHIMA, Kyoto (JP)

(21) Appl. No.: 18/768,379

(22) Filed: Jul. 10, 2024

(30) Foreign Application Priority Data
Jul. 11, 2023 (JP) 2023-113602

(51) Int. Cl. H02M 1/084; H02M 1/00; H02M 3/158

(52) U.S. Cl. CPC H02M 1/0845; H02M 1/0025; H02M 3/1586

(57) ABSTRACT

A power supply controller provided in a switching power supply configured to generate an output voltage from an input voltage includes: a synchronous input terminal; a synchronous output terminal; an output stage configured to power-convert the input voltage to the output voltage; a switching control circuit configured to power-convert the input voltage to the output voltage by performing switching control of the output stage in synchronization with a reference clock signal; a synchronous output circuit configured to set a state of the synchronous output terminal to any one of a plurality of output states including first, second, and third output states; and a synchronous input circuit configured to set a state of the synchronous input terminal to any one of a plurality of input states including first and second input states.

### CROSS-REFERENCE TO RELATED APPLICATION

This application is based upon and claims the benefit of priority from Japanese Patent Application No. 2023-113602, filed on Jul. 11, 2023, the entire contents of which are incorporated herein by reference.

### TECHNICAL FIELD

The present disclosure relates to a power supply controller and a switching power supply.

### BACKGROUND

A method of configuring a multi-phase DC/DC converter by synchronizing DC/DC converters for multiple channels is known in the related art.

### BRIEF DESCRIPTION OF DRAWINGS

The accompanying drawings, which are incorporated in and constitute a part of the specification, illustrate embodiments of the present disclosure.

FIG. 1 is an overall configuration diagram of a switching power supply according to an embodiment of the present disclosure.

FIG. 2 is an external perspective view of a power supply controller according to an embodiment of the present disclosure.

FIG. 3 is an overall configuration diagram of a switching power supply device according to an embodiment of the present disclosure.

FIG. 4 is an internal configuration diagram of a power supply controller according to an embodiment of the present disclosure.

FIG. 5 is an internal configuration diagram of a power supply controller in a first switch state according to an embodiment of the present disclosure.

FIG. 6 is an internal configuration diagram of a power supply controller in a second switch state according to an embodiment of the present disclosure.

FIG. 7 is a timing chart of a power supply controller according to an embodiment of the present disclosure.

FIG. 8 is a diagram showing an example of an internal configuration of a synchronous output circuit according to an embodiment of the present disclosure.

FIG. 9 is a diagram showing an example of an internal configuration of a synchronous input circuit according to an embodiment of the present disclosure.

FIG. 10 is an internal configuration diagram of a power supply controller according to an embodiment of the present disclosure.

FIG. 11 is a diagram for explaining a method of transmitting information from a rear stage side power supply controller to a front stage side power supply controller according to a first example belonging to an embodiment of the present disclosure.

FIG. 12 is a conceptual waveform diagram of a clock signal output from a front stage side power supply controller to a rear stage side power supply controller according to the first example belonging to an embodiment of the present disclosure.

FIG. 13 is a waveform diagram of a clock signal and a level detection signal when a synchronous input circuit is in a pull-down state in a rear stage side power supply controller according to the first example belonging to an embodiment of the present disclosure.

FIG. 14 is a waveform diagram of a clock signal and a level detection signal when a synchronous input circuit is in a pull-up state in a rear stage side power supply controller according to the first example belonging to an embodiment of the present disclosure.

FIG. 15 is a diagram showing how three clock signals are propagated among a plurality of power supply controllers according to the first example belonging to an embodiment of the present disclosure.

FIG. 16 is a diagram showing how two clock signals are propagated among a plurality of power supply controllers according to the first example belonging to an embodiment of the present disclosure.

FIG. 17 is an operation flowchart of a power supply controller operating in a first mode according to the first example belonging to an embodiment of the present disclosure.

FIG. 18 is an operation flowchart of a power supply controller operating in a second mode according to the first example belonging to an embodiment of the present disclosure.

FIG. 19 is a waveform diagram of four clock signals used for synchronizing switching in four power supply controllers according to the first example belonging to an embodiment of the present disclosure.

FIG. 20 is an internal configuration diagram of a synchronous output circuit according to the first example belonging to an embodiment of the present disclosure.

FIG. 21 is a conceptual waveform diagram of a clock signal output from a front stage side power supply controller to a rear stage side power supply controller according to a second example belonging to an embodiment of the present disclosure.

FIG. 22 is a waveform diagram of a clock signal and a level detection signal when a synchronous input circuit is in a pull-down state in the rear stage side power supply controller according to the second example belonging to an embodiment of the present disclosure.

FIG. 23 is a waveform diagram of a clock signal and a level detection signal when a synchronous input circuit is in a pull-up state in the rear stage side power supply controller according to the second example belonging to an embodiment of the present disclosure.

FIG. 24 is an operation flowchart of a power supply controller operating in a first mode according to the second example belonging to an embodiment of the present disclosure.

FIG. 25 is an operation flowchart of the power supply controller operating in a second mode according to the second example belonging to an embodiment of the present disclosure.

FIG. 26 is an internal configuration diagram of a synchronous output circuit according to the second example belonging to an embodiment of the present disclosure.

FIG. 27 is a waveform diagram of a clock signal that can be output from a front stage side power supply controller to a rear stage side power supply controller according to a fifth example belonging to an embodiment of the present disclosure.

FIG. 28 is a waveform diagram of four clock signals used for synchronizing switching in four power supply controllers according to the fifth example belonging to an embodiment of the present disclosure.

FIG. 29 is a waveform diagram of a clock signal that can be output from a front stage side power supply controller to a rear stage side power supply controller according to a sixth example belonging to an embodiment of the present disclosure.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

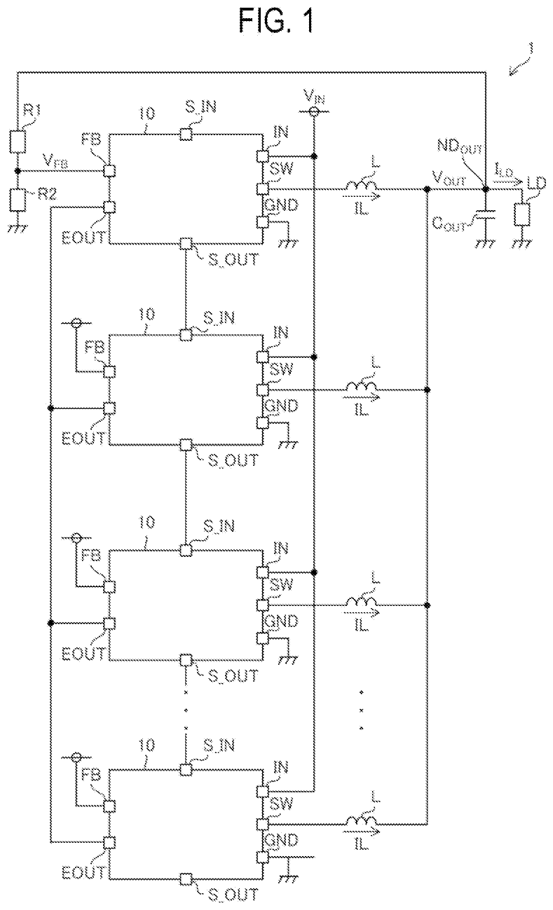

Examples of embodiments of the present disclosure will be specifically described below with reference to the drawings. Throughout the referred drawings, the same parts are denoted by the same reference numerals, and duplicate explanation thereof will be omitted in principle. In the present disclosure, for the sake of simplification of description, by describing a symbol or a code that refers to information, a signal, a physical quantity, a functional part, a circuit, an element, a component, etc., designation of the information, the signal, the physical quantity, the functional part, the circuit, the element, the component, etc., corresponding to the symbol or the code may be omitted or abbreviated. For example, a synchronous input terminal referred to by “S_IN” (see FIG. 1), which will be described later, may be described as a synchronous input terminal S_IN, or may be abbreviated as a terminal S_IN, but they refer to the same terminal.

First, some terms used in descriptions of embodiments of the present disclosure will be explained. A ground refers to a reference conductive portion having a reference potential of 0 V (zero volts) or refers to a potential of 0 V itself. The reference conductive portion may be formed of a conductor such as metal. The potential of 0 V may be referred to as a ground potential. In the embodiments of the present disclosure, a voltage shown without providing a particular reference represents a potential seen from the ground.

A level refers to a level of potential, with a high level having a higher potential than a low level for any signal or voltage of interest. For any signal of interest, when the signal is at a high level, an inversion of the signal takes a low level, and when the signal is at a low level, the inversion of the signal takes a high level. In any signal or voltage of interest, a transition from a low level to a high level is referred to as a rising edge, and a transition from a high level to a low level is referred to as a falling edge.

For any transistor configured as a FET (Field Effect Transistor), including a MOSFET, an on state refers to a state in which a drain and a source of the transistor are electrically connected to each other, and an off state refers to a state in which a drain and a source of the transistor are electrically disconnected (cut-off state) from each other. The same also applies to transistors that are not classified as FETs. Unless otherwise specified, a MOSFET is regarded as an enhancement type MOSFET. The MOSFET is an abbreviation for “metal-oxide-semiconductor field-effect transistor.” Moreover, it may be considered that a back gate is short-circuited to a source in any MOSFET unless otherwise specified.

Hereinafter, for any transistor, the on state and the off state may be simply expressed as on and off, respectively. For any transistor, a transition from an off state to an on state is expressed as turn-on, and a transition from an on state to an off state is expressed as turn-off. For any transistor, a period in which the transistor is in an on state is referred to as an on period, and a period in which the transistor is in an off state is referred to as an off period.

For any signal that takes a signal level of a high level or a low level, a period in which the signal level is at the high level is referred to as a high level period, and a period in which the signal level is at the low level is referred to as a low level period. The same applies to any voltage that takes a voltage level of a high level or a low level.

Connections among a plurality of parts forming a circuit, such as arbitrary circuit elements, wirings, and nodes, may be understood to refer to electrical connections, unless otherwise specified.

In a case where any two voltages to be compared are voltages v1 and v2, “v1>v2” means that the voltage v1 is higher than the voltage v2, and “v1<v2” means that the voltage v1 is lower than the voltage v2. The same also applies to other equations that include physical quantities other than a voltage.

FIG. 1 shows an overall configuration of a switching power supply 1 according to an embodiment of the present disclosure. The switching power supply 1 is supplied with a positive input voltage V_{IN} from a voltage source (not shown) and generates a positive output voltage V_{OUT} by stepping down the input voltage V_{IN}. Therefore, the output voltage V_{OUT} is lower than the input voltage V_{IN}. The switching power supply 1 stabilizes the output voltage V_{OUT} at a predetermined target voltage. That is, in a steady state, the output voltage V_{OUT} substantially matches the target voltage. Hereinafter, the target voltage is referred to by symbol “V_{TG}.” The switching power supply 1 includes n power supply controllers 10. Herein, n represents an arbitrary integer of 2 or more.

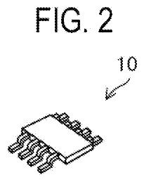

FIG. 2 is an external perspective view of one power supply controller 10. The power supply controller 10 is an electronic component including a semiconductor chip having a semiconductor integrated circuit formed on a semiconductor substrate, a housing (package) configured to accommodate the semiconductor chip, and a plurality of external terminals exposed to an outside of the power supply controller 10 from the housing. The power supply controller 10 is formed by enclosing the semiconductor chip in the housing (package) made of resin. The number of external terminals of the power supply controller 10 and a type of housing of the power supply controller 10 shown in FIG. 2 are merely examples and may be designed arbitrarily. The plurality of external terminals provided at the power supply controller 10 include an input terminal IN, a switch terminal SW, a ground terminal GND, a feedback terminal FB, an error output terminal EOUT, a synchronous input terminal S_IN, and a synchronous output terminal S_OUT. External terminals other than these may also be provided at the power supply controller 10. Further, the synchronous input terminal can be read differently as a synchronous clock input terminal and the synchronous output terminal can be read differently as a synchronous clock output terminal.

The switching power supply 1 includes n coils L, an output capacitor C_{OUT}, and feedback resistors R1 and R2, in addition to the n power supply controllers 10. The n coils L are associated with the n power supply controllers 10 on a one-to-one basis. That is, one coil L is associated with one power supply controller 10. A first end of a coil L associated with a certain power supply controller 10 is connected to a switch terminal SW of the certain power supply controller 10. Second ends of all the coils L are connected in common to an output node ND_{OUT}. In each coil L, a current flowing through the coil L is referred to as a coil current IL. In principle, the coil current IL flows from the switch terminal SW toward the output node ND_{OUT} (only the principle will be considered below).

An output capacitor C_{OUT} is interposed between the output node ND_{OUT} and the ground. That is, a first end of the output capacitor C_{OUT} is connected to the output node ND_{OUT}, and a second end of the output capacitor C_{OUT} is connected to the ground. A voltage at the output node ND_{OUT} is an output voltage V_{OUT}. A load LD is connected to the output node ND_{OUT}. The load LD is any load that is driven based on the output voltage V_{OUT}. A current supplied from the output node ND_{OUT} to the load LD is referred to as a load current I_{LD}.

A first end of the feedback resistor R1 is connected to the output node ND_{OUT}, a second end of the feedback resistor R1 is connected to the first end of the feedback resistor R2, and a second end of the feedback resistor R2 is connected to the ground. A feedback voltage V_{FB} corresponding to the output voltage V_{OUT} is generated at a connection node between the feedback resistors R1 and R2. The feedback voltage V_{FB} is a voltage division of the output voltage V_{OUT} and is therefore proportional to the output voltage V_{OUT}. The feedback resistors R1 and R2 form a feedback voltage generation circuit configured to generate the feedback voltage V_{FB}. The feedback terminal FB of one power supply controller 10 among the n power supply controllers 10 is connected to the connection node between the feedback resistors R1 and R2 and receives the feedback voltage V_{FB}. A sufficiently high voltage (for example, the input voltage V_{IN} or a power supply voltage VDD which will be described later) is applied to the feedback terminals FB of the other power supply controllers 10. The output voltage V_{OUT} itself may be used as the feedback voltage V_{FB}. In any case, the feedback voltage V_{FB} is a voltage according to the output voltage V_{OUT}.

The input voltage V_{IN} is supplied to the input terminal IN of each power supply controller 10. The ground terminal GND of each power supply controller 10 is connected to the ground. The n error output terminals EOUT in the n power supply controllers 10 are connected to each other. The n power supply controllers 10 may be referred to as first to n-th power supply controllers 10. Among these, the feedback voltage V_{FB} is input to the feedback terminal FB of the first power supply controller 10. The synchronous output terminal S_OUT of the i-th power supply controller 10 and the synchronous input terminal S_IN of the (i+1)-th power supply controller 10 are connected to each other via a wiring that connects them. Herein, i represents any integer. However, since a total number of the power supply controllers 10 is n, “i” in the (i+1)-th power supply controller 10 represents any natural number of (n−1) or less.

A set of one power supply controller 10 and one coil L cooperates with the output capacitor C_{OUT} to form a one-channel DC/DC converter configured to perform current mode control. Therefore, in the switching power supply 1, an n-channel DC/DC converter is formed. The output capacitor C_{OUT} is shared by the n-channel DC/DC converter. In the switching power supply 1, a signal (an error signal to be described later) corresponding to the feedback voltage V_{FB} is shared by the power supply controllers 10 of all channels, and multiphase control can be performed by shifting a phase of switching control among multiple channels.

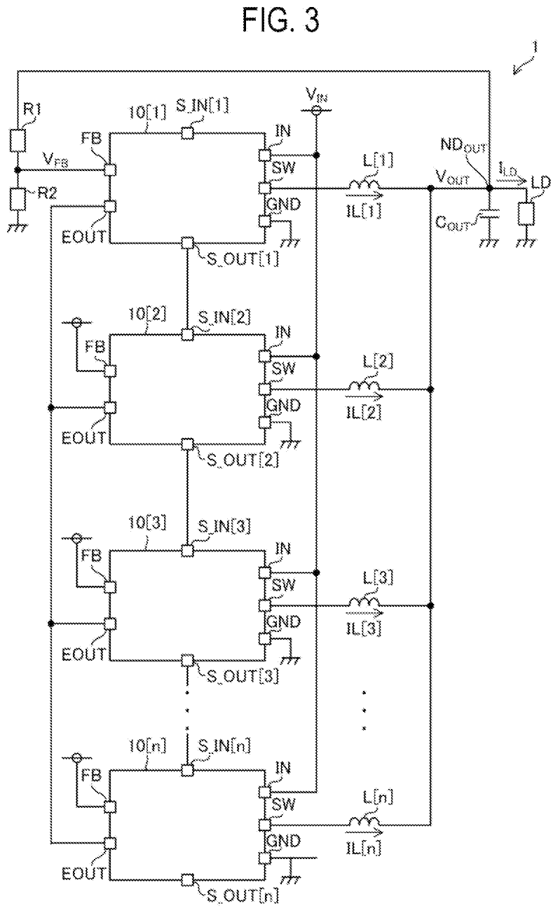

Hereinafter, when it is necessary to distinguish the n power supply controllers 10 from one another, the n power supply controllers 10 are referred to as power supply controllers 10[1] to 10[n], as shown in FIG. 3. Further, the coils L associated with the power supply controllers 10[1] to 10[n] are referred to as coils L[1] to L[n], respectively. That is, for each integer i that satisfies “1≤i≤n,” the switch terminal SW of the power supply controller 10[i] is connected to a first end of the coil L[i], and a second end of the coil L[i] is connected to the output node ND_{OUT}. A coil current IL flowing through the coil L[i] is particularly referred to as a coil current IL[i]. The power supply controllers 10[1] to 10[n] correspond to the above-described first to n-th power supply controllers, respectively. Therefore, only the feedback terminal FB of the power supply controller 10[1] is connected to the connection node between the feedback resistors R1 and R2 to receive the feedback voltage V_{FB}, and a sufficiently high voltage (for example, the input voltage V_{IN} or power supply voltage VDD which will be described later) is applied to each of the feedback terminals FB of the power supply controllers 10[2] to 10[n].

Further, the synchronous input terminal S_IN and the synchronous output terminal S_OUT in the power supply controller 10[i] may be particularly referred to as a synchronous input terminal S_IN[i] and a synchronous output terminal S_OUT[i], respectively. A clock signal may or may not be input from the outside to the synchronous input terminal S_IN[1]. For each integer i that satisfies “1≤i≤(n−1),” the synchronous output terminal S_OUT[i] and the synchronous input terminal S_IN[i+1] are connected to each other via a wiring provided between the power supply controllers 10[i] and 10[i+1]. Thus, for example, the terminals S_OUT[1] and S_IN[2] are connected to each other, the terminals S_OUT[2] and S_IN[3] are connected to each other, and the terminals S_OUT[3] and S_IN[4] are connected to each other.

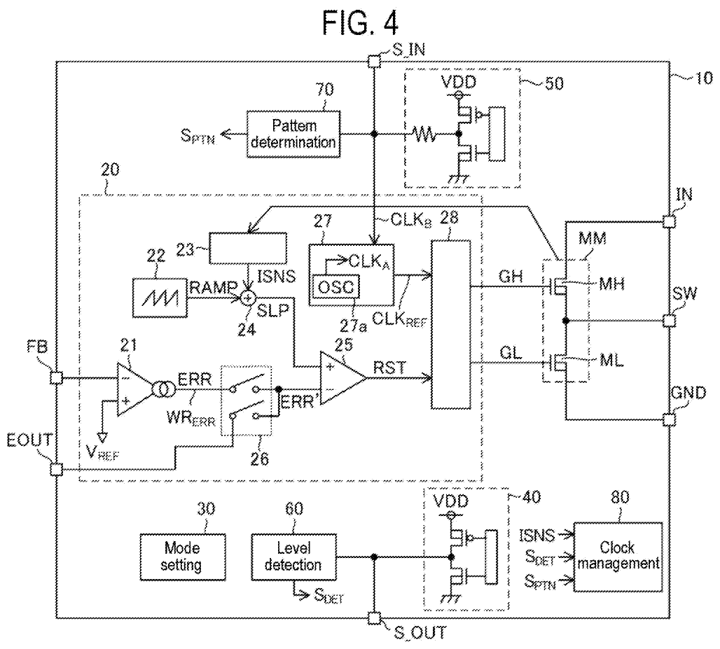

FIG. 4 shows an internal configuration of one power supply controller 10. Internal configurations of the power supply controllers 10[1] to 10[n] are the same. Therefore, the internal configuration of the power supply controller 10 will be described by focusing on one power supply controller 10. The power supply controller 10 includes an output stage MM and a switching control circuit 20 for controlling switching of the output stage MM and also includes a mode setting circuit 30, a synchronous output circuit 40, a synchronous input circuit 50, a level detection circuit 60, a pattern determination circuit 70, and a clock management circuit 80. Although not particularly illustrated, any circuit in the power supply controller 10 may output any signal or information to any other circuits. The synchronous output circuit may be read differently as a synchronous clock output circuit and the synchronous input circuit may be read differently as a synchronous clock input circuit. Hereinafter, in order to simplify the description, the power supply controllers 10 and 10[i] will be abbreviated as devices 10 and 10[i] in many cases.

The output stage MM includes transistors MH and ML configured as N-channel MOSFETs. The transistors MH and ML are a pair of switching elements connected in series between the input terminal IN and the ground terminal GND (in other words, the ground), and by controlling the switching of these transistors, the input voltage V_{IN} is switched and a rectangular waveform switch voltage appears at the switch terminal SW. The transistor MH is provided on a higher potential side than the transistor ML. Specifically, a drain of the transistor MH is connected to the input terminal IN, which is an application terminal of the input voltage V_{IN}, and is provided with the input voltage V_{IN}. A source of the transistor MH and a drain of the transistor ML are connected in common to the switch terminal SW. A source of the transistor ML is connected to the ground terminal GND (therefore, connected to the ground). However, a current detection resistor may be interposed between the source of the transistor ML and the ground terminal GND.

The transistor MH functions as an output element (output transistor), and the transistor ML functions as a rectifying element (synchronous rectifying transistor). In the switching control of the output stage MM, the output element (MH) and the rectifying element (ML) are alternately turned on and off. The coil L and the output capacitor C_{OUT} connected to the switch terminal SW constitute a rectifying/smoothing circuit configured to rectify and smooth the rectangular waveform switch voltage appearing at the switch terminal SW.

Gates of the transistors MH and ML are supplied with gate signals GH and GL as drive signals, respectively, and the transistors MH and ML are turned on and off according to the gate signals GH and GL. When the gate signal GH is at a high level, the transistor MH is turned on, and when the gate signal GH is at a low level, the transistor MH is turned off. Similarly, when the gate signal GL is at a high level, the transistor ML is turned on, and when the gate signal GL is at a low level, the transistor ML is turned off. Basically, the transistors MH and ML are alternately turned on and off, but both transistors MH and ML may be maintained in a turn-off state. The transistors MH and ML are not turned on at the same time. At least one selected from the group of the output element (MH) and the rectifying element (ML) may be provided outside the device 10. The entire output stage MM may be provided outside the device 10.

During the on-period of the transistor MH, the coil current IL flows through a channel (between the drain and source) of the transistor MH. During the off-period of the transistor MH, the coil current IL flows through a channel of the transistor ML or a parasitic diode of the transistor ML.

The input voltage V_{IN} is power-converted into the output voltage V_{OUT} by controlling the switching of the output stage MM. The switching control circuit 20 is in charge of switching control of the output stage MM and converts the input voltage V_{IN} into the output voltage V_{OUT} by controlling the switching of the output stage MM. In the switching control, the switching control circuit 20 controls the turn-on/off states of the transistors MH and ML through level control of the gate signals GH and GL, thereby generating a desired output voltage V_{OUT} at the output node ND_{OUT}. When two or more switching control circuits 20 in two or more devices 10 perform switching control at the same time, the input voltage V_{IN} is converted into the output voltage V_{OUT} by cooperation of the two or more devices 10.

Although not particularly shown, the device 10 is provided with an internal power supply circuit configured to generate various internal power supply voltages based on the input voltage V_{IN}. Each circuit within the device 10 is driven based on the input voltage V_{IN} or internal power supply voltages. The power supply voltage VDD is generated as one of the internal power supply voltages. The power supply voltage VDD has a predetermined positive DC voltage value. Further, the gate signal GL is a signal with the ground potential as a reference, whereas the gate signal GH is a signal with the potential of the switch terminal SW as a reference. The gate signal GH at a low level has the potential of the switch terminal SW, and the gate signal GH at a high level is higher than the potential of the switch terminal SW by a predetermined voltage. In this case, the predetermined voltage is larger than a gate threshold voltage of the transistor MH. A boosted power supply configured to generate the gate signal GH can be generated by using a well-known bootstrap circuit (not shown). The transistor MH may be configured with a P-channel MOSFET, and in such a case, a boosted power supply is not required.

As a modification, the device 10 may adopt a diode rectification method. In this case, instead of the transistor ML, a synchronous rectifying diode having an anode connected to the ground terminal GND and a cathode connected to the switch terminal SW is used as the rectifying element. In this case, only the output element (MH) is turned on/off in the switching control of the output stage MM. In any case, the output voltage V_{OUT} is generated based on the current (IL) flowing through the coil L by switching the output element (MH) between turn-on and turn-off in the switching control of the output stage MM.

Before describing an operation of the switching control circuit 20, the mode setting circuit 30 provided in the device 10 will be described.

The mode setting circuit 30 sets an operating mode of the device 10 to a first mode or a second mode. The operating mode of the device 10 (hereinafter simply referred to as the operating mode) may be understood as an operation mode of the components (the circuits 20, 40, 50, 60, 70, and 80) of the device 10 other than the mode setting circuit 30.

In the switching power supply 1, only the operation mode of the device 10[1] is set to the first mode, and the operation modes of the devices 10[2] to 10[n] are all set to the second mode. The mode setting circuit 30 of the device 10[i] sets the operating mode of the device 10[i] based on mode setting information given to the device 10[i].

Herein, the voltage of the feedback terminal FB is used as the mode setting information. In the switching power supply 1, the feedback voltage V_{FB} is supplied only to the feedback terminal FB of the device 10[1]. In the specifications of the switching power supply 1, it is determined that the feedback voltage V_{FB} has a voltage value within a specified range. The specified range is a voltage range from 0 V to a predetermined voltage V_{FBH} (for example, 1.0 V). The mode setting circuit 30 of the device 10[i] sets the operation mode of the device 10[i] to the first mode when the voltage of the feedback terminal FB of the device 10[i] is equal to or lower than a predetermined threshold voltage V_{THMODE}, and sets the operating mode of the device 10[i] to the second mode when the voltage of the feedback terminal FB of the device 10[i] is higher than the predetermined threshold voltage V_{THMODE}. In this case, “V_{THMODE}>V_{FBH}” is established.

Since the feedback voltage V_{FB} is supplied to the feedback terminal FB of the device 10[1], the voltage of the feedback terminal FB of the device 10[1] is equal to or lower than the threshold voltage V_{THMODE}. Therefore, the mode setting circuit 30 of the device 10[1] sets the operation mode of the device 10[1] to the first mode. On the other hand, in the switching power supply 1, a voltage (for example, the input voltage V_{IN} or the power supply voltage VDD) exceeding the threshold voltage V_{THMODE} is applied to each feedback terminal FB of the devices 10[2] to 10[n]. Therefore, the mode setting circuits 30 of the devices 10[2] to 10[n] set the operation modes of the devices 10[2] to 10[n] to the second mode, respectively.

Each device 10 may be provided with a dedicated external terminal (not shown) configured to set the operation mode. In this case, an input voltage to the dedicated external terminal functions as the mode setting information. Then, the mode setting circuit 30 of the device 10[i] may set the operation mode of the device 10[i] to the first mode when the input voltage to the dedicated external terminal of the device 10[i] is equal to or lower than the threshold voltage V_{THMODE}, and set the operation mode of the device 10[i] to the second mode when the input voltage to the dedicated external terminal of the device 10[i] is higher than the threshold voltage V_{THMODE} (the reverse is also possible). Alternatively, the mode setting information may be stored in a memory (not shown) within the device 10. A host system (not shown) that is connected to the device 10 such that bidirectional communication can be performed between the host system and the device 10 can write the mode setting information to the memory within the device 10.

The mode setting circuit 30 supplies a mode setting signal indicating a setting result of the operation mode for each circuit in the device 10. Specifically, when setting the operation mode of the device 10[i] to the first mode, the mode setting circuit 30 of the device 10[i] supplies a first mode setting signal indicating to that effect for each circuit within the device 10[i]. When setting the operation mode of the device 10[i] to the second mode, the mode setting circuit 30 of the device 10[i] supplies a second mode setting signal indicating to that effect for each circuit within the device 10[i]. Hereinafter, the device 10 in the first mode refers to a device 10 for which the first mode is set to the operating mode, and the device 10 in the second mode refers to a device 10 for which the second mode is set to the operating mode.

The switching control circuit 20 includes an error amplifier 21, a ramp circuit 22, a sense circuit 23, an adder 24, a PWM comparator 25, a switch circuit 26, a clock supply circuit 27, and a controller 28.

The error amplifier 21 is a current output type trans-conductance amplifier. The error amplifier 21 includes an inverting input terminal, a non-inverting input terminal, and an output terminal. The inverting input terminal of the error amplifier 21 is connected to the feedback terminal FB. A predetermined reference voltage V_{REF} is supplied to the non-inverting input terminal of the error amplifier 21. The reference voltage V_{REF} is a DC voltage having a predetermined positive voltage value and is generated by a reference voltage generation circuit (not shown) within the device 10. The output terminal of the error amplifier 21 is connected to a wiring WR_{ERR}.

The error amplifier 21 operates only in the device 10 in the first mode, and the error amplifier 21 stops in the device 10 in the second mode. In the device 10[i], the first mode setting signal or the second mode setting signal from the mode setting circuit 30 is supplied to the switching control circuit 20. The switching control circuit 20 operates the error amplifier 21 when the first mode setting signal is supplied to the switching control circuit 20, and stops the error amplifier 21 (stops the operation of the error amplifier 21) when the second mode setting signal is supplied to the switching control circuit 20. Therefore, among the error amplifiers 21 of the devices 10[1] to 10[n], only the error amplifier 21 of the device 10 in the first mode, that is, only the error amplifier 21 of the device 10[1], operates. Further, when starting up the device 10 [1], soft start control may be performed to gradually increase the value of the reference voltage V_{REF} from 0 V to a predetermined positive voltage value, but in the following, the existence of soft start control will be ignored.

In the device 10[1], the feedback voltage V_{FB} is input to the inverting input terminal of the error amplifier 21. In the device 10[1], the error amplifier 21 outputs a current signal corresponding to a difference between the feedback voltage V_{FB} and the reference voltage V_{REF} from an output terminal of the error amplifier 21, thereby generating an error signal ERR on the wiring WR_{ERR} according to the difference between the feedback voltage V_{FB} and the reference voltage V_{REF}. The error signal ERR, and a ramp signal RAMP, a sense signal ISNS, and a slope signal SLP, which will be described later, are all voltage signals. For any voltage signal, a rise or a fall in the voltage signal means a rise or a fall in a potential of the voltage signal. The same applies to other similar expressions.

In the device 10[1], when the feedback voltage V_{FB} is lower than the reference voltage V_{REF}, the error amplifier 21 outputs a current from the output terminal of the error amplifier 21 toward the wiring WR_{ERR} such that the potential of the error signal ERR rises. When the feedback voltage V_{FB} is higher than the reference voltage V_{REF}, the error amplifier 21 draws a current from the wiring WR_{ERR} toward the output terminal of the error amplifier 21 such that the potential of the error signal ERR falls. Although not particularly illustrated, a phase compensation circuit including a capacitor may be connected between the wiring WR_{ERR} and the ground.

The ramp circuit 22 generates the ramp signal RAMP having a potential that monotonically rises at a predetermined rate of change from a predetermined initial voltage V_{INT} during the on-period of the transistor MH. The initial voltage V_{INT} is, for example, 0 V, but may be different from 0 V. During the off-period of the transistor MH, the potential of the ramp signal RAMP is fixed at the initial voltage V_{INT}.

The sense circuit 23 detects the coil current IL and generates the sense signal ISNS indicating the detection result of the coil current IL. The sense signal ISNS has a voltage value proportional to the value of the coil current IL with a positive proportionality coefficient. Therefore, as the coil current IL increases, the potential of the sense signal ISNS rises, and as the coil current IL decreases, the potential of the sense signal ISNS falls. The coil current IL detected by the sense circuit 23 of the device 10[i] is the coil current IL[i].

The sense circuit 23 can generate the sense signal ISNS by detecting a current flowing through the transistor MH (accordingly, the coil current IL) during the on-period of the transistor MH or detecting a current flowing through the transistor ML (accordingly, the coil current IL) during the on-period of the transistor ML. Alternatively, a shunt resistor (not shown) may be interposed between a connection node between the transistors MH and ML and the coil L, and in such a case, the sense circuit 23 can generate the sense signal ISNS based on the voltage drop across the shunt resistor. In addition, the sense signal ISNS may be generated by detecting a voltage at an arbitrary location where a voltage corresponding to the coil current IL is generated. The sense signal ISNS indicates the detected value of the coil current IL only during the on-period of the transistor MH. The sense signal ISNS is fixed to the ground potential during the off-period of the transistor MH.

The adder 24 adds the sense signal ISNS to the ramp signal RAMP to generate the slope signal SLP which is a sum signal thereof. That is, “SLP=RAMP+ISNS.”

The slope signal SLP is input to the non-inverting input terminal of the PWM comparator 25, and an error signal ERR′ is input to the inverting input terminal of the PWM comparator 25.

In this case, the switch circuit 26 is provided among the inverting input terminal of the PWM comparator 25, the wiring WR_{ERR}, and the error output terminal EOUT. The switch circuit 26 has either a first switch state or a second switch state. The switching control circuit 20 sets the switch circuit 26 to the first switch state when the first mode setting signal is supplied to the switching control circuit 20, and sets the switch circuit 26 to the second switch state when the second mode setting signal is supplied to the switching control circuit 20. Therefore, the switch circuit 26 of the device 10[1] is set to the first switch state, and each switch circuit 26 of the devices 10[2] to 10[n] is set to the second switch state.

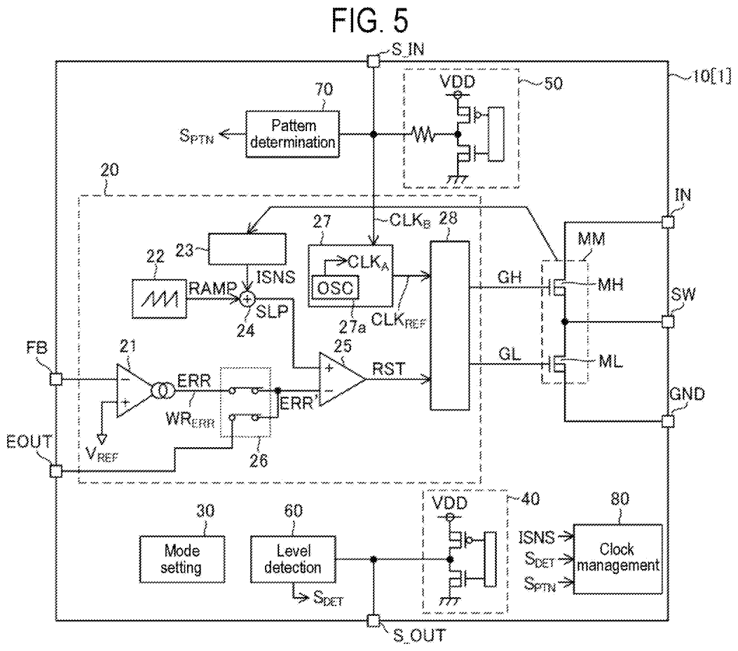

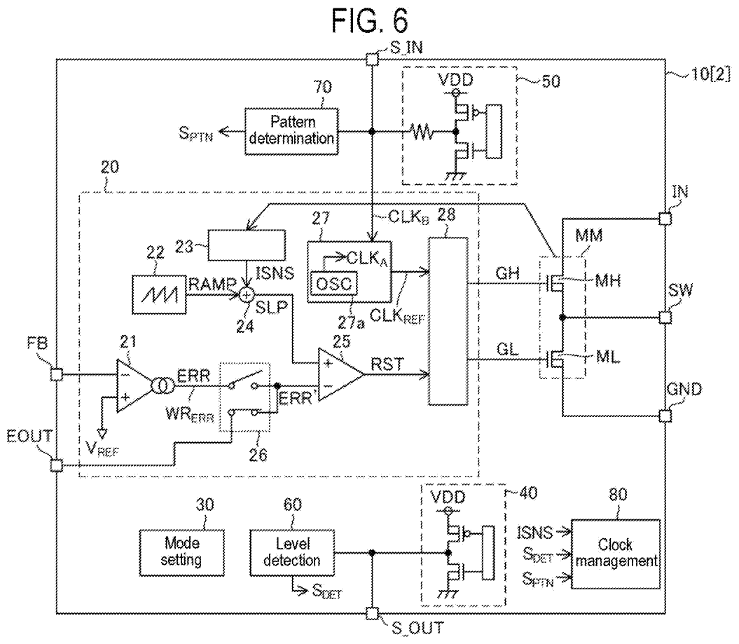

FIG. 5 shows how the switch circuit 26 of the device 10[1] is set to the first switch state, and FIG. 6 shows how the switch circuit 26 of the device 10[2] is set to the second switch state. As shown in FIG. 5, the switch circuit 26 in the first switch state connects the wiring WR_{ERR} to the inverting input terminal of the PWM comparator 25 and the error output terminal EOUT. Therefore, the error signal ERR′ of the device 10[1] matches the error signal ERR generated by the error amplifier 21 within the device 10[1]. As shown in FIG. 6, the switch circuit 26 in the second switch state disconnects the wiring WR_{ERR} from the inverting input terminal of the PWM comparator 25 and connects the error output terminal EOUT to the inverting input terminal of the PWM comparator 25. As described above, since all the error output terminals EOUT in the devices 10[1] to 10[n] are connected to one another (see FIG. 3), the error signals ERR′ of the devices 10[2] to 10[n] also match the error signal ERR generated by the error amplifier 21 within the device 10[1].

The PWM comparator 25 compares the error signal ERR′ and the slope signal SLP which are input to the PWM comparator 25 and generates and outputs a signal RST indicating a result of the comparison. The PWM comparator 25 outputs the signal RST at a low level when the potential of the error signal ERR′ is higher than the potential of the slope signal SLP, and outputs the signal RST at a high level when the potential of the slope signal SLP is higher than the potential of the error signal ERR′. When “ERR′=SLP,” the signal RST has a high level or a low level.

The clock supply circuit 27 includes an oscillation circuit 27a. The oscillation circuit 27a generates and outputs an internal clock signal CLK_{A} having a predetermined frequency f_{PWM}. The clock supply circuit 27 is connected to the synchronous input terminal S_IN. A clock signal different from the internal clock signal CLK_{A} may be input to the synchronous input terminal S_IN of a certain device 10 from another device 10 or from an external clock supply circuit (not shown). The clock signal input to the synchronous input terminal S_IN is referred to as an input clock signal CLK_{B}. Any clock signal has alternately a high level and a low level. The clock supply circuit 27 supplies a clock signal based on the internal clock signal CLK_{A} or a clock signal based on the input clock signal CLK_{B} to the controller 28, as a reference clock signal CLK_{REF}. Basically, the internal clock signal CLK_{A} or the input clock signal CLK_{B} may be supplied, as it is, to the controller 28, as the reference clock signal CLK_{REF}. However, a signal, which is obtained by logically inverting the internal clock signal CLK_{A} or the input clock signal CLK_{B}, or a waveform-shaped signal may be supplied to the controller 28, as the reference clock signal CLK_{REF}. Hereinafter, it is assumed that the internal clock signal CLK_{A} or the input clock signal CLK_{B} is supplied to the controller 28 as the reference clock signal CLK_{REF} unless otherwise stated.

Among the oscillation circuits 27a of the devices 10[1] to 10[n], only the oscillation circuit 27a of the device 10 in the first mode, that is, only the oscillation circuit 27a of the device 10[1] operates. Therefore, in the device 10[1], the internal clock signal CLK_{A} or the input clock signal CLK_{B} becomes the reference clock signal CLK_{REF}. In each of the devices 10[2] to 10[n], the reference clock signal CLK_{REF} is generated only when the input clock signal CLK_{B} is supplied to the synchronous input terminal S_IN, and in such a case, the input clock signal CLK_{B} becomes the reference clock signal CLK_{REF}. Further, the clock supply circuit 27 can determine whether or not the input clock signal CLK_{B} is supplied to the synchronous input terminal S_IN based on a signal of the synchronous input terminal S_IN.

When the first mode setting signal is supplied from the mode setting circuit 30 to the switching control circuit 20, the clock supply circuit 27 supplies the input clock signal CLK_{B}, as the reference clock signal CLK_{REF}, to the controller 28 during a period when the input clock signal CLK_{B} is supplied to the synchronous input terminal S_IN, and supplies the internal clock signal CLK_{A}, as the reference clock signal CLK_{REF}, to the controller 28 during a period when the input clock signal CLK_{B} is not supplied to the synchronous input terminal S_IN. Therefore, in the device 10[1] operating in the first mode, the clock supply circuit 27 supplies the input clock signal CLK_{B}, as the reference clock signal CLK_{REF}, to the controller 28 during the period when the input clock signal CLK_{B} is supplied to the synchronous input terminal S_IN[1], and supplies the internal clock signal CLK_{A}, as the reference clock signal CLK_{REF}, to the controller 28 during the period when the input clock signal CLK_{B} is not supplied to the synchronous input terminal S_IN[1]. Therefore, during the period when the input clock signal CLK_{B} is supplied to the synchronous input terminal S_IN[1], the switching of the output stage MM of the device 10[1] is controlled in synchronization with the input clock signal CLK_{B} to the synchronous input terminal S_IN[1]. During the period in which the input clock signal CLK_{B} is not supplied to the synchronous input terminal S_IN[1], the switching of the output stage MM of the device 10[1] is controlled in synchronization with the internal clock signal CLK_{A} generated in the device 10[1].

When the second mode setting signal is supplied from the mode setting circuit 30 to the switching control circuit 20, the clock supply circuit 27 supplies the input clock signal CLK_{B}, as the reference clock signal CLK_{REF}, to the controller 28 during the period when the input clock signal CLK_{B} is supplied to the synchronous input terminal S_IN, and supplies no clock signal to the controller 28 during the period when the input clock signal CLK_{B} is not supplied to the synchronous input terminal S_IN. Therefore, in the device 10[i] (where i is an integer of 2 or more and n or less) operating in the second mode, the clock supply circuit 27 supplies the input clock signal CLK_{B}, as the reference clock signal CLK_{REF}, to the controller 28 during the period when the input clock signal CLK_{B} is supplied to the synchronous input terminal S_IN[i], and supplies no clock signal to the controller 28 during the period when the input clock signal CLK_{B} is not supplied to the synchronous input terminal S_IN[i]. Therefore, for each integer i that satisfies “2≤i≤n,” during the period when the input clock signal CLK_{B} is supplied to the synchronous input terminal S_IN[i], the switching of the output stage MM of the device 10[i] is controlled in synchronization with the input clock signal CLK_{B} to the synchronous input terminal S_IN[i]. For each integer i that satisfies “2≤i≤n,” the switching control of the output stage MM of the device 10[i] is stopped during the period when the input clock signal CLK_{B} is not supplied to the synchronous input terminal S_IN[i]. In device 10[i], when the switching control of the output stage MM is stopped, the transistors MH and ML of the output stage MM are both fixed to turn-off.

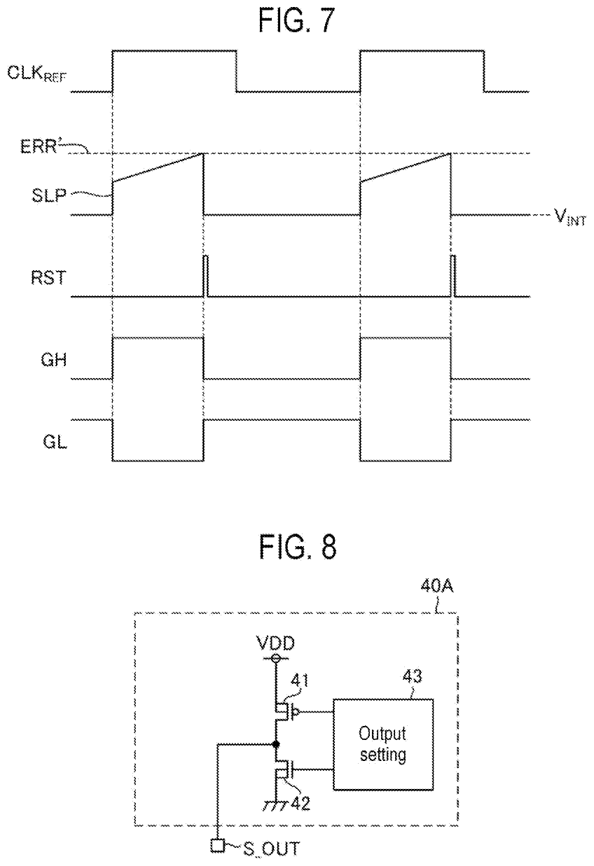

The reference clock signal CLK_{REF} and the signal RST from the PWM comparator 25 are input to the controller 28. The controller 28 performs the switching control of the output stage MM in synchronization with the reference clock signal CLK_{REF}. At this time, the controller 28 individually controls the states of the transistors MH and ML by supplying the gate signals GH and GL to the transistors MH and ML based on the signals CLK_{REF} and RST. FIG. 7 shows waveforms of the signals CLK_{REF}, ERR′, SLP, RST, GH and GL. A duty of the reference clock signal CLK_{REF} is not limited to a duty as shown in FIG. 7, but is arbitrary.

In response to a predetermined set edge in the reference clock signal CLK_{REF}, the controller 28 turns on the transistor MH by generating a rising edge in the gate signal GH and turns off the transistor ML by generating a falling edge in the gate signal GL. The above-mentioned set edge is a rising edge in the example of FIG. 7. Therefore, in response to a rising edge in the reference clock signal CLK_{REF}, the controller 28 according to the example of FIG. 7 generates a rising edge in the gate signal GH and a falling edge in the gate signal GL. However, the above-mentioned set edge may be a falling edge.

After turning on the transistor MH and turning off the transistor ML, through a monotonous rise of the slope signal SLP, a rising edge occurs in the signal RST when the potential of the slope signal SLP transitions from a state in which the potential of the slope signal SLP is lower than the potential of the error signal ERR′ to a state in which the potential of the slope signal SLP is higher than the potential of the error signal ERR′. When the rising edge occurs in the signal RST, the controller 28 generates a falling edge in the gate signal GH to turn off the transistor MH and generates a rising edge in the gate signal GL to turn on the transistor ML. As the transistor MH is turned off, the potential of the ramp signal RAMP falls to a sufficiently low initial voltage V_{INT}, such that the potential of the slope signal SLP returns to the state in which the potential of the slope signal SLP is lower than the potential of the error signal ERR′, and a falling edge is quickly generated in the signal RST.

When “V_{OUT}=V_{TG},” “V_{FB}=V_{REF}.” Starting from a state in which “V_{OUT}=V_{TG}” is established, when the state becomes a state of “V_{OUT}<V_{TG}” through an increase in the load current I_{LD}, etc., the state becomes a state of “V_{FB}<V_{REF},” such that the potential of the error signal ERR of the device 10[1] rises, and in conjunction therewith, the potential of the error signal ERR′ of each of the devices 10[1] to 10[n] also rises. In the device 10 where the switching control is performed, the rise of the potential of the error signal ERR′ causes an increase in the on-period of the transistor MH. As the on-period of the transistor MH increases, the coil current IL increases, and as a result, the output voltage V_{OUT} rises toward the target voltage V_{TG}. Conversely, starting from the state in which “V_{OUT}=V_{TG}” is established, when the state becomes a state of “V_{OUT}>V_{TG}” through a decrease in the load current I_{LD}, etc., the state becomes a state of “V_{FB}>V_{REF},” such that the potential of the error signal ERR falls, and in conjunction therewith, the potential of the error signal ERR′ of each of the devices 10[1] to 10[n] also falls. In the device 10 where the switching control is performed, the fall of the potential of the error signal ERR′ causes a decrease in the on-period of the transistor MH. As the on-period of the transistor MH decreases, the coil current IL decreases, and as a result, the output voltage V_{OUT} falls toward the target voltage V_{TG}. In this way, in the switching power supply 1 (in the device 10 where the switching control is performed), control is performed to reduce a difference between the output voltage V_{OUT} and the target voltage V_{TG}.

The synchronous output circuit 40 is connected to the synchronous output terminal S_OUT and outputs a signal from the synchronous output terminal S_OUT. The synchronous output circuit 40 operates based on the power supply voltage VDD. The synchronous output circuit 40 sets the state of the synchronous output terminal S_OUT to one of a plurality of output states including a low level output state, a high level output state, and a Hi-Z state. In the present embodiment, the state of the synchronous output terminal S_OUT and the state of the synchronous output circuit 40 are understood to be synonymous with each other. Therefore, the synchronous output terminal S_OUT being in the low level output state and the synchronous output circuit 40 being in the low level output state refer to the same thing. The same applies to the high level output state and the Hi-Z state.

The synchronous output circuit 40 outputs a signal at a low level with sufficiently low output impedance from the synchronous output terminal S_OUT in the low level output state and outputs a signal at a high level with sufficiently low output impedance from the synchronous output terminal S_OUT in the high level output state. In the Hi-Z state, the synchronous output circuit 40 makes the output impedance of the synchronous output terminal S_OUT higher than the output impedance in the low level output state and the output impedance in the high level output state. In the switching power supply 1 of FIG. 1, the output impedance of the synchronous output circuit 40 in the device 10[i] refers to the output impedance when the synchronous output circuit 40 of the device 10[i] outputs a signal to the outside of the device 10[i] via the synchronous output terminal S_OUT.

FIG. 8 shows a configuration of a synchronous output circuit 40A which is an example of the synchronous output circuit 40. The synchronous output circuit 40A includes a transistor 41 which is a P-channel MOSFET, a transistor 42 which is an N-channel MOSFET, and an output setting circuit 43. A source of the transistor 41 is connected to an application terminal of the power supply voltage VDD and is supplied with the power supply voltage VDD. Each of drains of the transistors 41 and 42 is connected to the synchronous output terminal S_OUT. A source of the transistor 42 is connected to the ground. The output setting circuit 43 is connected to each of gates of the transistors 41 and 42 and individually sets the states of the transistors 41 and 42 to be turned on or turned off by controlling the respective gate potentials of the transistors 41 and 42.

When the output setting circuit 43 turns off the transistor 41 and turns on the transistor 42, the state of the synchronous output terminal S_OUT is a low level output state and the synchronous output circuit 40A outputs a low level signal from the synchronous output terminal S_OUT. When the output setting circuit 43 turns on the transistor 41 and turns off the transistor 42, the state of the synchronous output terminal S_OUT is a high level output state and the synchronous output circuit 40A outputs a high level signal from the synchronous output terminal S_OUT. The output impedance of the synchronous output circuit 40A in the low level output state is equal to an on-resistance of the transistor 42, and the output impedance of the synchronous output circuit 40A in the high level output state is equal to an on-resistance of the transistor 41. When both transistors 41 and 42 are set to turn-off by the output setting circuit 43, the state of the synchronous output terminal S_OUT is a Hi-Z state. The output impedance of the synchronous output circuit 40A in the Hi-Z state is much larger than the on-resistance of the transistor 41 and the on-resistance of the transistor 42. Hereinafter, the on-resistances of the transistors 41 and 42 are considered to be sufficiently small and will be ignored.

Regarding signals or voltages at the synchronous output terminal S_OUT and the synchronous input terminal S_IN, a high level refers to a level equal to or higher than a predetermined upper threshold voltage V_{THH} and a low level refers to a level equal to or lower than a predetermined lower threshold voltage V_{THL}. In this case, “VDD>V_{THH}>V_{THL}>0” is established. For example, the upper threshold voltage V_{THH} is set to 0.7 times the power supply voltage VDD, and the lower threshold voltage V_{THL} is set to 0.3 times the power supply voltage VDD.

The plurality of output states regarding the synchronous output circuit 40 may include other output states (for example, a state in which a signal with an intermediate potential which is not classified as either a high level or a low level is output from the synchronous output terminal S_OUT) that do not belong to any of the low level output state, the high level output state, and the Hi-Z state.

Referring again to FIG. 4, the synchronous input circuit 50 is connected to the synchronous input terminal S_IN. The synchronous input circuit 50 operates based on the power supply voltage VDD. The synchronous input circuit 50 sets the state of the synchronous input terminal S_IN to one of a plurality of input states including a pull-down state and a pull-up state. In the present embodiment, the state of the synchronous input terminal S_IN and the state of the synchronous input circuit 50 are understood to be synonymous with each other. Therefore, the synchronous input terminal S_IN being in a pull-down state and the synchronous input circuit 50 being in a pull-down state refer to the same thing, and the synchronous input terminal S_IN being in a pull-up state and the synchronous input circuit 50 being in a pull-up state refer to the same thing.

The synchronous input circuit 50 pulls down the synchronous input terminal S_IN to a low level through a pull-down resistor in the pull-down state and pulls up the synchronous input terminal S_IN to a high level through a pull-up resistor in the pull-up state. The pull-down resistor and the pull-up resistor may be a common resistor, or may be two independent resistors.

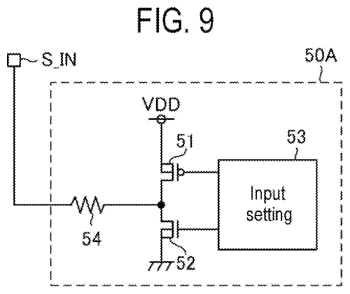

FIG. 9 shows a configuration of a synchronous input circuit 50A which is an example of the synchronous input circuit 50. The synchronous input circuit 50A includes a transistor 51 which is a P-channel MOSFET, a transistor 52 which is an N-channel MOSFET, an input setting circuit 53, and a resistor 54. A source of the transistor 51 is connected to an application terminal of the power supply voltage VDD and is supplied with the power supply voltage VDD. A first end of the resistor 54 is connected to the synchronous input terminal S_IN. A second end of the resistor 54 is connected to each of drains of the transistors 51 and 52. A source of the transistor 52 is connected to the ground. The input setting circuit 53 is connected to each of gates of the transistors 51 and 52 and individually sets the states of the transistors 51 and 52 to turn-on or turn-off by controlling the respective gate potentials of the transistors 51 and 52.

When the input setting circuit 53 turns off the transistor 51 and turns on the transistor 52, since the synchronous input terminal S_IN is pulled down to the ground (low level) via the resistor 54 and the transistor 52, the state of the synchronous input terminal S_IN is the pull-down state. When the input setting circuit 53 turns on the transistor 51 and turns off the transistor 52, since the synchronous input terminal S_IN is pulled up to the application terminal (high level) of the power supply voltage VDD via the resistor 54 and the transistor 51, the state of the synchronous input terminal S_IN is the pull-up state. On-resistance values of the transistors 51 and 52 are sufficiently smaller than a value of the resistor 54. Hereinafter, the on-resistances of the transistors 51 and 52 will be ignored. In the synchronous input circuit 50A, the resistor 54 functions as a pull-down resistor in the pull-down state, and the resistor 54 functions as a pull-up resistor in the pull-up state, but a pull-down resistor and a pull-up resistor may be provided separately.

The value of the resistor 54 is sufficiently larger than the output impedance of the synchronous output terminal S_OUT in the low level output state and the output impedance of the synchronous output terminal S_OUT in the high level output state and is sufficiently smaller than the output impedance of the synchronous output terminal S_OUT in the Hi-Z state.

A plurality of input states regarding the synchronous input circuit 50 can include other input states (for example, a state in which both the transistors 51 and 52 are set to turn-off) that do not belong to either the pull-down state or the pull-up state.

Hereinafter, unless otherwise stated, it is assumed that the synchronous output circuit 40A and the synchronous input circuit 50A are used as the synchronous output circuit 40 and the synchronous input circuit 50, respectively.

Referring again to FIG. 4, the level detection circuit 60 is connected to the synchronous output terminal S_OUT and outputs a level detection signal S_{DET} according to the level of the synchronous output terminal S_OUT. The pattern determination circuit 70 is connected to the synchronous input terminal S_IN and outputs a pattern determination signal S_{PTN} according to a pattern of a signal supplied to the synchronous input terminal S_IN. The signals S_{DET} and S_{PTN} are binary signals having a value of “1” or “0.” The clock management circuit 80 manages and controls the state of the synchronous output circuit 40 based on information including the sense signal ISNS, the level detection signal S_{DET}, and the pattern determination signal S_{PTN}. Details of the circuits 60, 70, and 80 will be described later.

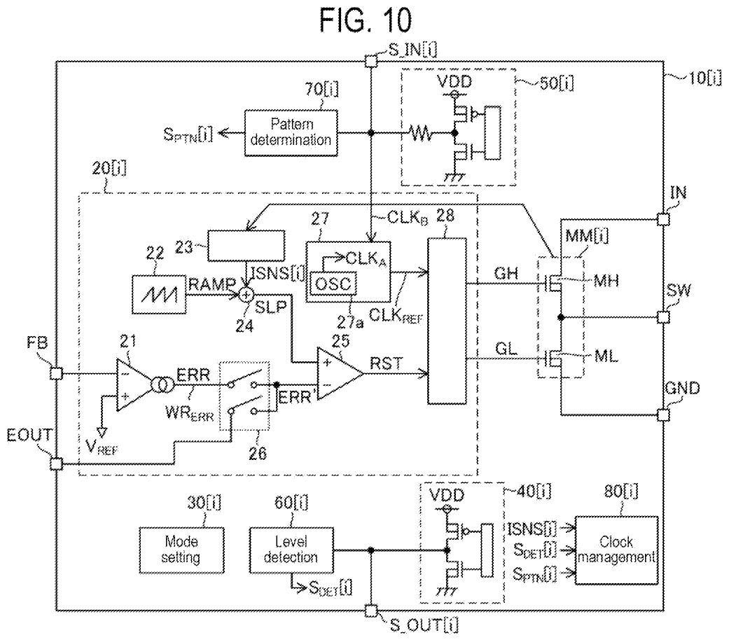

Further, hereinafter, for the sake of convenience of description, similarly to the synchronous input terminal S_IN and the synchronous output terminal S_OUT in the device 10[i] being referred to by the symbols “S_IN[i]” and “S_OUT[i],” respectively, as shown in FIG. 10, the output stage MM, the switching control circuit 20, the mode setting circuit 30, the synchronous output circuit 40, the synchronous input circuit 50, the level detection circuit 60, the pattern determination circuit 70, and the clock management circuit 80 in the device 10[i] are referred to by symbols “MM[i],” “20[i],” “30[i],” “40[i],” “50[i],” “60[i],” “70[i],” and “80[i],” respectively. Further, the sense signal ISNS, the level detection signal S_{DET}, and the pattern determination signal S_{PTN} in the device 10[i] are referred to by symbols “ISNS[i],” “S_{DET}[i],” and “S_{PTN}[i],” respectively.

### <<Reference Power Supply>>

Before describing detailed operation examples of the switching power supply 1, some reference power supplies will be described. In a first reference power supply, DC/DC converters for multiple channels are built into one electronic component. In the first reference power supply, multiphase control can be easily realized by shifting a phase of switching control of each channel based on an internal clock signal generated within one electronic component. In the first reference power supply, since the operation state of the DC/DC converter of each channel in one electronic component can be grasped, it is relatively easy to increase or decrease the number of channels to be operated according to a load current.

On the other hand, there is a method (hereinafter, referred to as a multi-component method) in which a multi-phase DC/DC converter is formed with a plurality of electronic components separated from each other, such as the switching power supply 1 shown in FIG. 1. When the multi-component method is adopted, one electronic component as a main electronic component is in charge of main control and gives commands related to operations to other electronic components. For example, in a second reference power supply that constitutes a 4-phase DC/DC converter, the main electronic component individually sends clock signals to the remaining three electronic components (sub-electronic components) to achieve multiphase control. However, in this case, since as many clock signal output terminals and output circuits as the number of sub-electronic components are required, a size of each electronic component increases.

In consideration of this, in a third reference power supply, a plurality of electronic components each being in charge of switching control for one channel are connected in cascade. That is, in the third reference power supply, a clock signal for synchronization is transmitted from a main electronic component in charge of a first phase to a sub-electronic component in charge of a second phase, a clock signal for synchronization is transmitted from the sub-electronic component in charge of the second phase to a sub-electronic component in charge of a third phase, and a clock signal for synchronization is transmitted from the sub-electronic component in charge of the third phase to a sub-electronic component in charge of a fourth phase. A four-phase DC/DC converter can be configured by transmitting the clock signals for synchronization such that the phases of the clock signals used for switching control are shifted among the four electronic components.

However, in the third reference power supply, the main electronic component cannot recognize how many sub-electronic components are connected when viewed from the main electronic component, and cannot know how many sub-electronic components among them are in the operating state either. In the third reference power supply, when a plurality of power supply controllers (plurality of electronic components) and a plurality of coils are connected in the same manner as the switching power supply 1 of FIG. 1, in principle, the same magnitude of current flows through a coil corresponding to a main power supply controller (main electronic component) and a coil corresponding to a sub-power supply controller (sub electronic component). Therefore, in a case where a total number of electronic components in the operating state is known, it is also possible to know a load current (the total number of electronic components in the operating state× a current flowing through one coil). However, in the third reference power supply formed by simply connecting the plurality of electronic components in cascade, the load current cannot be known by the main electronic component (the same applies to the sub-electronic components). As a result, it is difficult to increase or decrease the number of operated channels (the total number of electronic components in the operating state) depending on the load current.

In a case where it is possible to transmit information from a device 10 placed in the rear stage to a device 10 placed in the front stage without adding a dedicated terminal, this is advantageous because it becomes possible to control operation/non-operation of each channel depending on the load current.

Hereinafter, among a plurality of examples, specific configuration examples, operation examples, application techniques, modification techniques, etc. related to the switching power supply 1 will be described. The matters described above in the present embodiment are applied to each of the following examples unless otherwise stated and unless contradictory (however, the matters regarding the first to third reference power supplies are excluded). In each example, in a case where there are matters that contradict the above-described matters, the description in each example may take precedence. In addition, as long as there is no contradiction, matters described in any of the following examples may be applied to any other examples (that is, it is also possible to combine any two or more of the examples).

### First Example

A first example will be described. In the first example, it is assumed that the synchronous input terminal S_IN of the device 10[1] is open. That is, in the first Example, the input clock signal CLK_{B} is not supplied to the synchronous input terminal S_IN of the device 10[1]. Therefore, in the first example, the controller 28 of the device 10[1] performs the switching control of an output stage MM[1] by using the internal clock signal CLK_{A} generated within the device 10[1], as the reference clock signal CLK_{REF}.

In the switching power supply 1, by using a signal between the terminals S_OUT and S_IN, a clock signal for synchronization can be transmitted from the device 10[i] to the device 10[i+1], and information can be transmitted from the device 10[i+1] to the device 10[i].

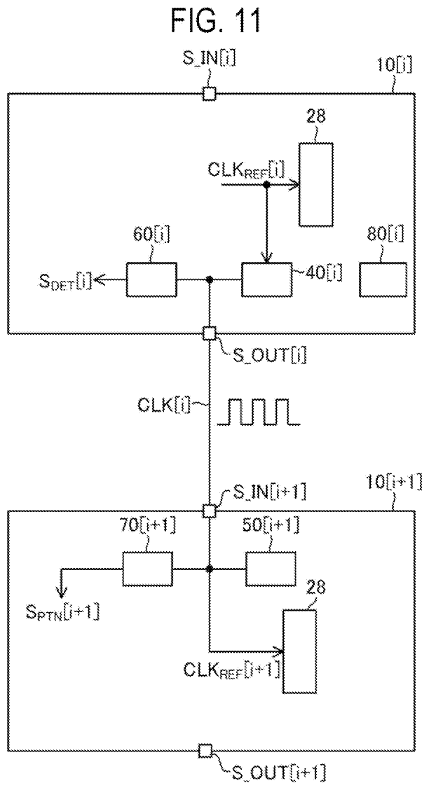

A method of transmitting the information from the device 10[i+1] to the device 10[i] will be described with reference to FIG. 11. A clock signal for synchronization is output from the synchronous output circuit 40[i]. The clock signal output by the synchronous output circuit 40[i] is referred to as a clock signal CLK[i]. The reference clock signals CLK_{REF} of the devices 10[i] and 10[i+1] are particularly represented by symbols “CLK_{REF}[i]” and “CLK_{REF}[i+1],” respectively. Hereinafter, a period during which switching control is executed may be referred to as a switching execution period and a period during which switching control is not executed may be referred to as a switching stop period. A period during which the clock signal CLK[i] is output by the synchronous output circuit 40[i] may be referred to as an output period of the clock signal CLK[i], and a period during which the clock signal CLK[i] is not output by the synchronous output circuit 40[i] may be referred to as a non-output period of the clock signal CLK[i] or a stop period of the clock signal CLK[i].

In any device 10[i], during a period when the switching control is executed by the switching control circuit 20[i] and the clock signal CLK[i] is not output from the synchronous output circuit 40[i], the clock management circuit 80[i] monitors whether or not a predetermined clock output condition is satisfied. Then, when the clock output condition is satisfied, the clock management circuit 80[i] controls the synchronous output circuit 40[i] to output the clock signal CLK[i] based on the reference clock signal CLK_{REF}[i] from the synchronous output terminal S_OUT[i], and as a result, the clock signal CLK[i] is output. When the clock output condition is not satisfied, the synchronous output circuit 40[i] does not output the clock signal CLK[i]. When the clock signal CLK[i] is not output, the state of the synchronous output terminal S_OUT[i] may be fixed to the Hi-Z state by the synchronous output circuit 40[i].

The clock signal CLK[i] is an output clock signal for the device 10[i] and an input clock signal for the device 10[i+1]. The device 10[i+1] receives the clock signal CLK[i] as the input clock signal at the synchronous input terminal S_IN[i+1] and performs switching control by using the clock signal CLK[i] as the reference clock signal CLK_{REF}[i+1].

The synchronous output circuit 40[i] generates the clock signal CLK[i] by shifting the phase of the reference clock signal CLK_{REF}[i] such that the clock signals CLK_{REF}[i] and CLK[i] have the same frequency and different phases.

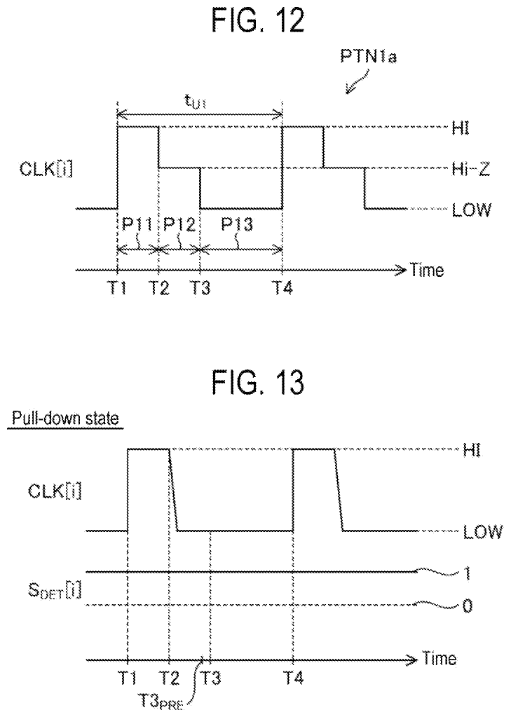

FIG. 12 shows a conceptual waveform diagram of the clock signal CLK[i]. As time elapses, times T1, T2, T3, and T4 arrive in this order. Unit time t_{U1}, which is a time difference between times T1 and T4, has a length of one cycle of the clock signal CLK[i] and, in the first example, matches a length of one cycle (that is, a reciprocal of the frequency f_{PWM}) of the internal clock signal CLK_{A}. In the first example, each cycle of any clock signal is considered to start from the rising edge of the clock signal.

At time T1, the synchronous output circuit 40[i] switches the state of the synchronous output terminal S_OUT[i] from the low level output state to the high level output state. Thereafter, at time T2, the synchronous output circuit 40[i] switches the state of the synchronous output terminal S_OUT[i] from the high level output state to the Hi-Z state. Further thereafter, at time T3, the synchronous output circuit 40[i] switches the state of the synchronous output terminal S_OUT[i] from the Hi-Z state to the low level output state. Further thereafter, at time T4, the synchronous output circuit 40[i] switches the state of the synchronous output terminal S_OUT[i] from the low level output state to the high level output state. Thereafter, the same operations are repeated. When time T1 is the start time of the j-th cycle of the clock signal CLK[i], time T4 corresponds to the start time of the (j+1)-th cycle of the clock signal CLK[i]. In this case, j represents any natural number.

As described above, the synchronous output circuit 40[i] includes a period P11 (between times T1 and T2 in FIG. 12) during which the state of the synchronous output terminal S_OUT[i] is set to the high level output state, a period P13 (between times T3 and T4 in FIG. 12) during which the state of the synchronous output terminal S_OUT[i] is set to the low level output state, and a period P12 (between times T2 and T3 in FIG. 12) during which the state of the synchronous output terminal S_OUT[i] is set to the Hi-Z state, in each cycle of the clock signal CLK[i] during the output period of the clock signal CLK[i]. For example, lengths of the periods P11, P12, and P13 are 25%, 25%, and 50% of the unit time t_{U1}, respectively. However, proportions of the periods P11, P12, and P13 in the unit time t_{U1} may be arbitrary. The output pattern of the clock signal CLK[i] by the synchronous output circuit 40[i] of the first example is referred to as a pattern PTN1a.

On-resistance values of the transistors 41 and 42 are negligibly smaller than the value of the resistor 54 (see FIGS. 8 and 9). Therefore, when the state of the synchronous output terminal S_OUT[i] is the low level output state, the clock signal CLK[i] is at a low level (substantially has a ground potential), and when the state of the synchronous output terminal S_OUT[i] is the high level output state, the clock signal CLK[i] is at a high level (substantially has the potential of the power supply voltage VDD). During the period when the state of the synchronous output terminal S_OUT[i] is the Hi-Z state (that is, the period between times T2 and T3), the level of the clock signal CLK[i] depends on the state of the synchronous input circuit 50[i+1].

FIG. 13 shows a waveform of the clock signal CLK[i] when the synchronous input circuit 50[i+1] is in the pull-down state. When the synchronous input circuit 50[i+1] is in the pull-down state, the potential of the clock signal CLK[i] falls from the potential of the power supply voltage VDD toward the ground potential after time T2 and falls to a potential belonging to a low level before time T3_{PRE}. The time T3_{PRE} is after time T2 and before time T3 by a predetermined minute time.

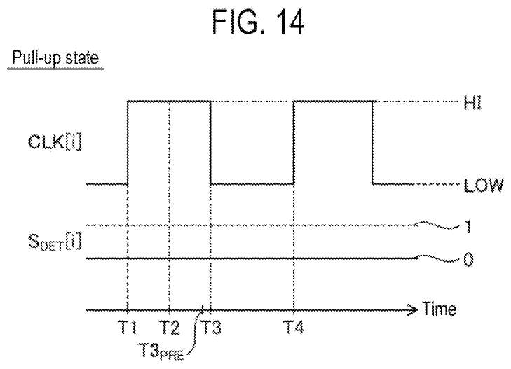

FIG. 14 shows a waveform of the clock signal CLK[i] when the synchronous input circuit 50[i+1] is in the pull-up state. When the synchronous input circuit 50[i+1] is in the pull-up state, the potential of the clock signal CLK[i] is maintained at the potential of the power supply voltage VDD (therefore, maintained at a high level) after time T2, via time T3_{PRE}, and until time T3, and the potential of the clock signal CLK[i] sharply falls from the potential of the power supply voltage VDD to the ground potential with time T3 as a boundary.

When the clock signal CLK[i] is output by the synchronous output circuit 40[i], the level detection circuit 60[i] specifies a voltage of the synchronous output terminal S_OUT[i] at time T3_{PRE} as a detection target voltage and detects which one of a high level or a low level the detection target voltage belongs to. The level detection circuit 60[i] determines that the detection target voltage belongs to the high level in a case where the detection target voltage is equal to or higher than an upper threshold voltage V_{THH}, and determines that the detection target voltage belongs to the low level in a case where the detection target voltage is equal to or lower than a lower threshold voltage V_{THL}.

When the level detection circuit 60[i] determines that the detection target voltage belongs to the low level, it outputs the level detection signal S_{DET}[i] of “1” (see FIG. 13). When the level detection signal S_{DET}[i] of “1” is output, “S_{DET}[i]=1” is maintained thereafter until it is determined that the detection target voltage belongs to the high level. When the level detection circuit 60[i] determines that the detection target voltage belongs to the high level, it outputs the level detection signal S_{DET}[i] of “0” (see FIG. 14). When the level detection signal S_{DET}[i] of “0” is output, “S_{DET}[i]=0” is maintained thereafter until it is determined that the detection target voltage belongs to the low level. The level detection signal S_{DET}[i] does not have a significant value during the non-output period of the clock signal CLK[i].

As described above, by switching the synchronous input circuit 50[i+1] between the pull-down state and the pull-up state, the information can be transmitted from the rear stage side device 10[i+1] to the front stage side device 10[i]. Further, a rising edge always occurs in the clock signal CLK[i] at time T1 regardless of the state of the synchronous input circuit 50[i+1]. Therefore, by using the rising edge of the clock signal CLK[i], switching can be synchronized between the devices 10[i] and 10[i+1]. In order to ensure this synchronization, in the first example in which the pattern PTN1a of FIG. 12 is employed, the set edge is a rising edge. That is, when the clock signal CLK[i] of the pattern PTN1a is supplied to the device 10[i+1], the controller 28 of the device 10[i+1] turns on the transistor MH and turns off the transistor ML in response to the rising edge of the clock signal CLK[i].

In any device 10[i], during a period when switching control is executed by the switching control circuit 20[i] and the clock signal CLK[i] is output from the synchronous output circuit 40[i], the clock management circuit 80 [i] monitors whether or not a predetermined clock stop condition is satisfied. Then, when the clock stop condition is satisfied, the clock management circuit 80[i] controls the synchronous output circuit 40[i] to stop the output of the clock signal CLK[i] from the synchronous output terminal S_OUT[i], and as a result, the output of the clock signal CLK[i] is stopped.

In the first example, the following first rule is adopted in each device 10. The device 10[i] according to the first rule sets the state of the synchronous input terminal S_IN[i] to the pull-down state during the output period of the clock signal CLK[i], while setting the state of the synchronous input terminal S_IN[i] to the pull-up state during the non-output period of the clock signal CLK[i].

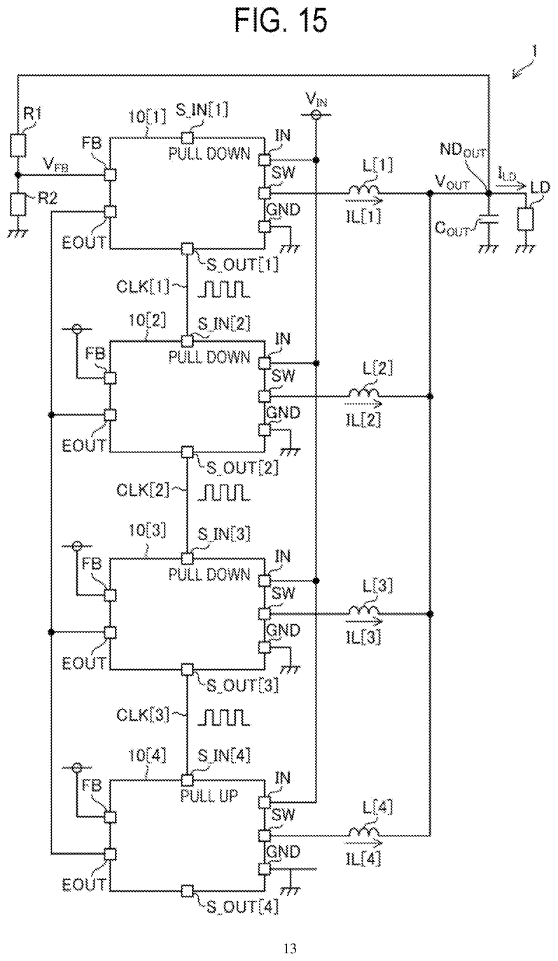

FIG. 15 shows the state of the switching power supply 1 when clock signals CLK[1] to CLK[3] are output in the case of “n=4.” In response to the output of the clock signals CLK[1] to CLK[3, the synchronous input terminals S_IN[1] to S_IN[3] are set to the pull-down state. In the state of FIG. 15, a clock signal CLK[4] is not output, and therefore, the synchronization input terminal S_IN[4] is set to the pull-up state. When the clock signal CLK[4] is output from the synchronous output terminal S_OUT[4], the synchronous input terminal S_IN[4] is set to the pull-down state (however, the device 10 that receives the clock signal CLK[4] does not exist). In the state of FIG. 15, by performing switching control in each of the devices 10[1] to 10[4], significant coil currents IL[1] to IL[4] are generated.

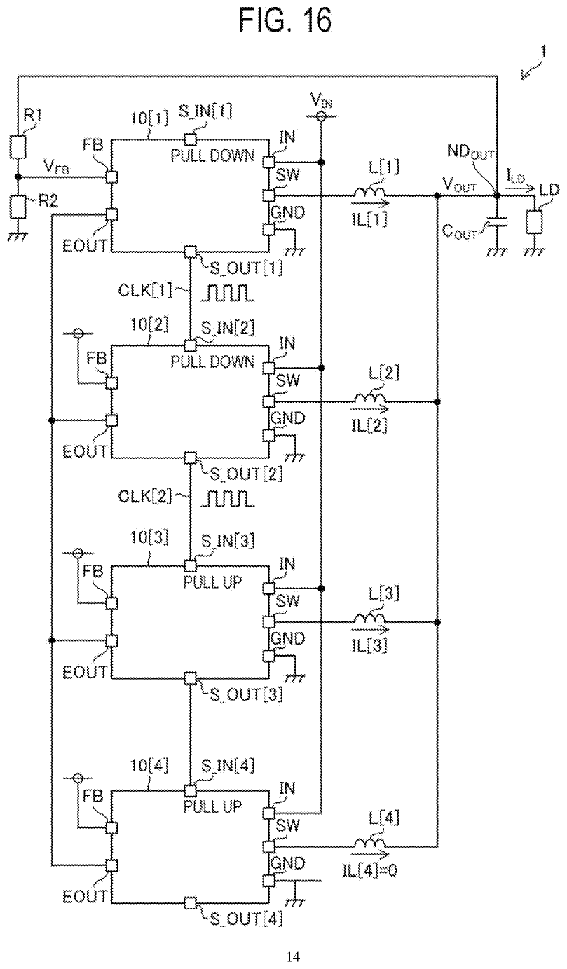

FIG. 16 shows the state of the switching power supply 1 when the clock signals CLK[1] and CLK[2] are output and the clock signal CLK[3] is not output in the case of “n=4.” In response to the output of the clock signals CLK[1] and CLK[2], the synchronous input terminals S_IN[1] and S_IN[2] are set to the pull-down state, while in response to non-output of the clock signal CLK[3], the synchronous input terminal S_IN[3] is set to the pull-up state. Further, in the example of FIG. 16, in the device 10[4] that does not receive the clock signal CLK[3], the synchronous input terminal S_IN[4] is set to the pull-up state which is the initial state. Not limited to the examples in FIGS. 15 and 16, but only in the device 10[1] operating in the first mode, the state of the synchronous input terminal S_IN[i] may be arbitrary regardless of whether or not the clock signal CLK[1] is output. In the state of FIG. 16, by performing switching control in each of the devices 10[1] to 10[3], significant coil currents IL[1] to IL[3] are generated, but since the switching control in the device 10[4] is stopped, a coil current IL[4] is zero.

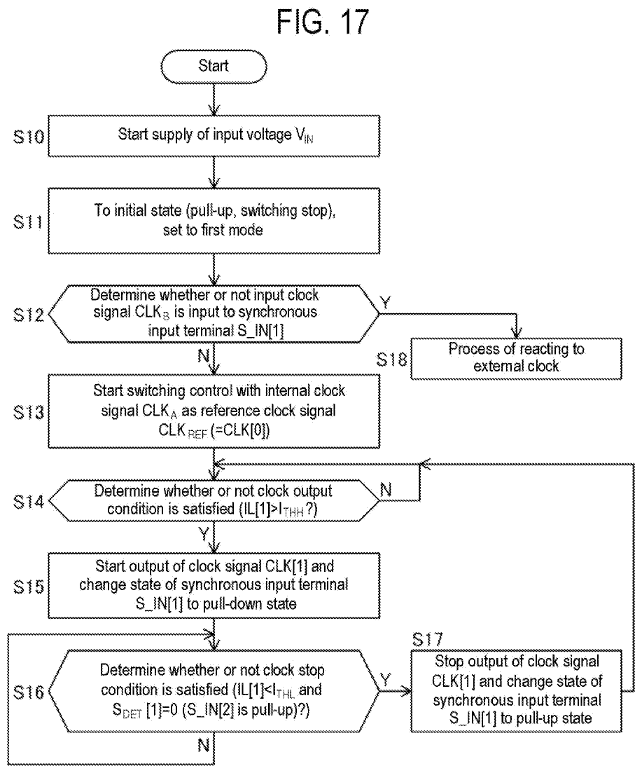

FIG. 17 shows an operation flowchart of the device 10[1] operating in the first mode. A flow of operation of the device 10[1] will be described with reference to FIG. 17.

First, in step S10, the device 10[1] is activated by starting the supply of the input voltage V_{IN} to the device 10[1]. In the subsequent step S11, a predetermined initialization process is performed in the device 10[1], such that the state of the device 10[1] becomes an initial state. In the initial state, the synchronous input terminal S_IN[1] is in a pull-up state, and switching control is stopped. Further, in the initialization process, the mode setting circuit 30 sets the operation mode of the device 10[1] to the first mode. After step S11, the process proceeds to step S12.

In step S12, it is determined whether or not the clock signal CLK_{B} is input to the synchronous input terminal S_IN[1]. When the clock signal CLK_{B} is input to the synchronous input terminal S_IN[1], the process proceeds from step S12 to step S18 where a process of reacting to an external clock (details thereof will be shown in other examples) is executed. When the clock signal CLK_{B} is not input to the synchronous input terminal S_IN[1], the process proceeds from step S12 to step S13. In the first example, since it is assumed that the clock signal CLK_{B} is not input to the synchronous input terminal S_IN[1], the process proceeds to step S13. As a modification, the process may always proceed to step S13 after step S11.

In the device 10[1] operating in the first mode, the internal clock signal CLK_{A} is supplied to the controller 28, as the reference clock signal CLK_{REF}. For the sake of convenience of description, the reference clock signal CLK_{REF} supplied to the controller 28 of the device 10[1] may be hereinafter referred to as a clock signal CLK[0].

In step S13, the device 10[1] starts switching control of the output stage MM[1] in synchronization with the clock signal CLK[0]. The controller 28 of the device 10[1] turns on the transistor MH and turns off the transistor ML in response to the rising edge of the clock signal CLK[0]. A coil current IL[1] is generated by the switching control of the device 10[1]. The coil current IL[1] is periodically detected by the sense circuit 23 of the device 10[1], and a sense signal ISNS[1] indicating a detected value of the coil current IL[1] is generated. After step S13, the process proceeds to step S14.

In step S14, the clock management circuit 80[1] determines whether or not the clock output condition is satisfied by comparing the detected coil current IL[1] with a predetermined upper threshold current I_{THH} based on the sense signal ISNS[1]. The establishment of the clock output condition in step S14 corresponds to the establishment of “IL[1]>I_{THH}.” When “IL[1]>I_{THH}” is established in step S14, a transition to step S15 occurs. When “IL[1]>I_{THH}” is not established, the process returns to step S14 where the determination on whether or not the clock output condition is satisfied (that is, determination on whether or not “IL[1]>I_{THH}” is established) is repeated.

In step S15, the clock management circuit 80[1] controls the synchronous output circuit 40[1] to cause the synchronous output circuit 40[1] to start the output of the clock signal CLK[1]. Further, in step S15, the clock management circuit 80[1] changes the state of the synchronous input terminal S_IN[1] from the pull-up state to the pull-down state by controlling the synchronous input circuit 50[1]. After step S15, the process proceeds to step S16.

In step S16, the clock management circuit 80[1] determines whether or not the clock stop condition is satisfied. When the clock stop condition is not satisfied, the determination process in step S16 is repeated. When the clock stop condition is satisfied, a transition from step S16 to step S17 occurs. The clock stop condition will be described later.

In step S17, the clock management circuit 80[1] controls the synchronous output circuit 40[1] to cause the synchronous output circuit 40[1] to stop the output of the clock signal CLK[1]. Further, in step S17, the clock management circuit 80[1] changes the state of the synchronous input terminal S_IN[1] from the pull-down state to the pull-up state by controlling the synchronous input circuit 50[1]. After step S17, the process returns to step S14.

The clock stop condition in step S16 is satisfied only when the detected coil current IL[1] satisfies “IL[1]<I_{THL}” and the value of the level detection signal S_{DET}[1] is “0.” It may be determined based on the sense signal ISNS[1] whether or not “IL[1]<I_{THL}” is established. I_{THL} represents a predetermined lower threshold current that is lower than the upper threshold current I_{THH}. “S_{DET}[1]=0” indicates that the synchronous input terminal S_IN[2] is in the pull-up state (see FIG. 14), that is, the clock signal CLK[2] is not output (therefore, the switching control of a device 10[3] is stopped). In other words, assuming that the drive (switching control) of the device 10[3] is stopped, when the coil current IL[1] falls below the lower threshold current I_{THL}, it is determined that the drive of the device 10[2] is also unnecessary, and then, the output of the clock CLK[1] is stopped (S17).

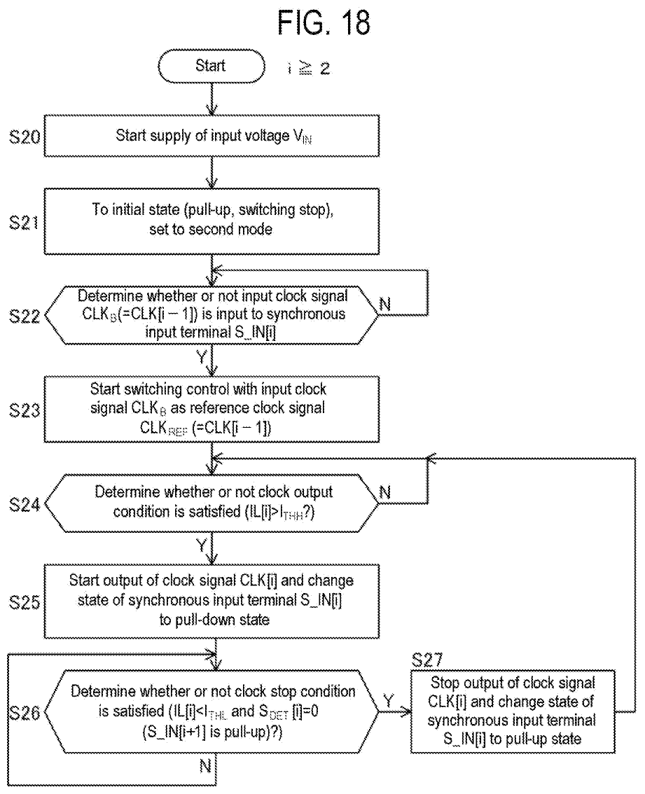

FIG. 18 shows an operation flowchart of the device 10[i] operating in the second mode. A variable i in each step (S20 to S28) shown in FIG. 18 represents an arbitrary integer of 2 or more. A flow of operation of the device 10[i] operating in the second mode will be described with reference to FIG. 18.

First, in step S20, the device 10[i] is activated by starting the supply of input voltage V_{IN} to the device 10[i]. In the subsequent step S21, a predetermined initialization process is performed in the device 10[i], such that the state of the device 10[i] becomes an initial state. In the initial state, the synchronous input terminal S_IN[i] is in a pull-up state, and switching control is stopped. Further, in the initialization process, the mode setting circuit 30 sets the operation mode of the device 10[i] to the second mode (as described above, in this case, i is an arbitrary integer of 2 or more). After step S21, the process proceeds to step S22.

In step S22, it is determined whether or not the clock signal CLK_{B} is input to the synchronous input terminal S_IN[i]. For the device 10[i], the clock signal CLK_{B} that can be input to the synchronous input terminal S_IN[i] is a clock signal CLK[i−1] from the device 10[i−1]. When the clock signal CLK_{B} is not input to the synchronous input terminal S_IN[i], the determination process in step S22 is repeated. When the clock signal CLK_{B}(CLK[i−1]) is input to the synchronous input terminal S_IN[i], the process proceeds from step S22 to step S23.

In the device 10[i] operating in the second mode, the input clock signal CLK_{B}(CLK[i−1]) for the synchronous input terminal S_IN[i] is supplied to the controller 28, as the reference clock signal CLK_{REF}.

In step S23, the device 10[i] starts switching control of the output stage MM[i] in synchronization with the clock signal CLK[i−1] which is the reference clock signal CLK_{REF}. The controller 28 of the device 10[i] turns on the transistor MH and turns off the transistor ML in response to the rising edge of the clock signal CLK[i−1]. A coil current IL[i] is generated by the switching control of device 10[i]. The coil current IL[i] is periodically detected by the sense circuit 23 of the device 10[i], and a sense signal ISNS[i] indicating the detected value of the coil current IL[i] is generated. After step S23, the process proceeds to step S24.

In step S24, the clock management circuit 80[i] determines whether or not the clock output condition is satisfied by comparing the detected coil current IL[i] with the predetermined upper threshold current I_{THH} based on the sense signal ISNS[i]. The establishment of the clock output condition in step S24 corresponds to the establishment of “IL[i]>I_{THH}.” When “IL[i]>I_{THH}” is established in step S24, a transition to step S25 occurs. When “IL[i]>I_{THH}” is not established, the process returns to step S24 where the determination on whether or not the clock output condition is satisfied (that is, determination on whether or not “IL[i]>I_{THH}” is established) is repeated.

In step S25, the clock management circuit 80[i] controls the synchronous output circuit 40[i] to cause the synchronous output circuit 40[i] to start the output of the clock signal CLK[i]. Further, in step S25, the clock management circuit 80[i] changes the state of the synchronous input terminal S_IN[i] from the pull-up state to the pull-down state by controlling the synchronous input circuit 50[i]. After step S25, the process proceeds to step S26.

In step S26, the clock management circuit 80[i] determines whether or not the clock stop condition is satisfied. When the clock stop condition is not satisfied, the determination process in step S26 is repeated. When the clock stop condition is satisfied, a transition from step S26 to step S27 occurs. The clock stop condition will be described later.

In step S27, the clock management circuit 80[i] controls the synchronous output circuit 40[i] to cause the synchronous output circuit 40[i] to stop the output of the clock signal CLK[i]. Further, in step S27, the clock management circuit 80[i] changes the state of the synchronous input terminal S_IN[i] from the pull-down state to the pull-up state by controlling the synchronous input circuit 50[i]. After step S27, the process returns to step S24.

The clock stop condition in step S26 is established only when the detected coil current IL[i] satisfies “IL[i]<I_{THL}” and the value of the level detection signal S_{DET}[i] is “0.” It may be determined based on the sense signal ISNS[i] whether or not “IL[i]<I_{THL}” is established. “S_{DET}[i]=0” indicates that the synchronous input terminal S_IN[i+1] is in the pull-up state under the assumption that the device 10[i+1] exists (see FIG. 14). That is, “S_{DET}[i] 0” indicates that a clock signal CLK[i+1] is not output (therefore, the switching control of the device 10[i+2] is stopped). In other words, assuming that the drive (switching control) of the device 10[i+2] is stopped, when the coil current IL[i] falls below the lower threshold current I_{THL}, it is determined that the drive of the device 10[i+1] is also unnecessary, and then, the output of the clock CLK[i] is stopped (S27). However, in a case where “i=n−1,” the device 10[i+2] does not exist, and in a case where “i=n,” the devices 10[i+1] and 10[i+2] do not exist.

Although not particularly illustrated, after the process proceeds from step S22 to step S23, when the supply of the clock signal CLK[i−1] to the synchronous input signal S_IN[i] is interrupted, since no rising edge occurs in the reference clock signal CLK_{REF} within the device 10[i], the switching control of the device 10[i] is stopped. After the process proceeds from step S22 to step S23, the switching control circuit 20[i] monitors a signal change of the synchronous input signal S_IN[i]. In a case where there is no signal change of the synchronous input signal S_IN[i] for a certain period of time or more, it is sufficient that the switching control circuit 20[i] determines that the supply of the clock signal CLK[i−1] is interrupted, fixes the transistors MH and ML of the output stage MM[i] in the turn-off state, and then makes a transition to step S22.

In the switching power supply 1, switching control is performed on the output stages MM[1] to MM[m] among the output stages MM[1] to MM[n], and a current is supplied from the application terminal of the input voltage V_{IN} to the application terminal (the output node ND_{OUT}) of the output voltage V_{OUT} via the output stages MM[1] to MM[m]. In this case, m represents a natural number of n or less.

A specific example of the operation of the switching power supply 1 will be given assuming that “n=4.” As the supply of the input voltage V_{IN} to the respective devices 10[1] to 10[4] is started, switching control is first performed only in the device 10[1], and at that time, only the coil current IL[1] among the coil currents IL[1] to IL[4] is generated. When the load current I_{LD} is relatively large, since the clock output condition is satisfied in the device 10[1], the output of the clock signal CLK[1] is started, and the coil current IL[2] is generated in addition to the coil current IL[1]. Depending on the load current I_{LD}, the clock output condition is also sequentially established in the devices 10[2] and 10[3]. As a result, a state is reached in which all the devices 10[1] to 10[4] perform switching control (hereinafter, referred to as a 4-channel drive state; the state shown in FIG. 15). In the 4-channel drive state assumed in this case, the clock output condition is not satisfied in the device 10[4] and, as a result, the synchronous input terminal S_IN[4] is in a pull-up state.

Since current mode control is performed by using a common error signal among the devices 10[1] to 10[4], when the switching control is performed in each of the devices 10[1] to 10[4], magnitudes of the coil current IL[1] to IL[4] are approximately the same. In this manner, by operating the subsequent channels when the load current I_{LD} is relatively large, the current can be distributed. Now, a case is considered where the load current I_{LD} decreases starting from the 4-channel drive state. For concrete explanation, it is assumed that the lower threshold current I_{THL} is 1.0 A and the load current I_{LD} decreases from 5.0 A to 3.9 A starting from the 4-channel drive state. Due to this decrease, the coil currents IL[1] to IL[4] all decrease to 0.975 A (in this case, errors are ignored).

At this time, although it is detected that the coil current IL has fallen below the lower threshold current I_{THL} in each of the devices 10[1] to 10[4], the clock stop condition is satisfied only for the device 10[3] among the devices 10[1] to 10[3]. This is because in the 4-channel drive state corresponding to FIG. 15, only the signal S_{DET}[3] among the level determination signals S_{DET}[1] to S_{DET}[3] has “0” (see S16 in FIG. 17 and S26 in FIG. 18). Therefore, when the load current I_{LD} decreases from 5.0 A to 3.9 A starting from the 4-channel drive state, the output of the clock signal CLK[3] from the device 10[3] is stopped, and the 4-channel drive state corresponding to FIG. 15 changes to a state corresponding to FIG. 16 (hereinafter, referred to as a 3-channel drive state). When the output of the clock signal CLK[3] is stopped, the state of the synchronous input terminal S_IN[3] is changed from the pull-down state to the pull-up state. In the 3-channel drive state, only the devices 10[1] to 10[3] perform switching control. In a case where the load current I_{LD} is maintained at 3.9 A in the 3-channel drive state, the coil currents IL[1] to IL[3] are each stabilized at 1.3 A. Thereafter, when the load current I_{LD} decreases sufficiently, the switching control of the device 10[3] is also stopped by stopping the output of the clock signal CLK[2], and then, the switching control of the device 10[2] can also be stopped by stopping the output of the clock signal CLK[1].

As described above, in the switching power supply 1, by switching between pull-down and pull-up of the synchronous input terminal S_IN, information is transmitted from a device 10 placed in the rear stage to a device 10 placed in the front stage, without adding a dedicated terminal or the like. As a result, it becomes possible to control the operation/non-operation of each channel according to the load current I_{LD}.

In addition, when the load current decreases from 5.0 A to 3.9 A while four channels are being driven in the above-described third reference power supply, what each electronic component can recognize is the fact that a current of a coil connected to itself has been reduced to 0.975 A. At this time, in a case where a main electronic component placed at the first stage (corresponding to device 10[1]) stops the supply of a clock signal to the subsequent electronic component (corresponding to the device 10[2]), all electronic components connected to the main electronic component stop working. As a result, it becomes necessary to cover the load current of 3.9 A only by the channel of the main electronic component, which causes some inconvenience.

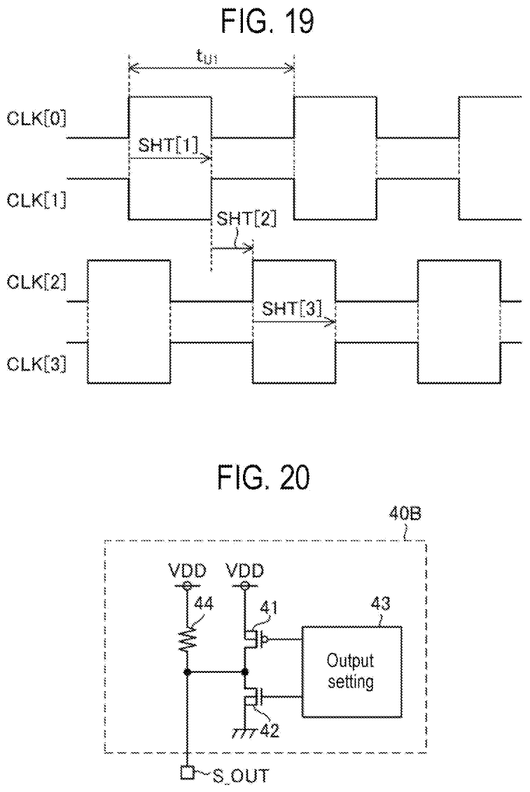

FIG. 19 shows waveforms of the clock signals CLK[0] to CLK[3] in the above-described 4-channel drive state. In FIG. 19, for the sake of convenience of illustration, it is assumed that the clock signals CLK[0] to CLK[3] are all rectangular wave signals with a duty of 50%, and the existence of the Hi-Z state is ignored.

In the 4-channel drive state, the clock signals CLK[0] to CLK[3] are reference clock signals CLK_{REF} in the devices 10[1] to 10[4], respectively. Therefore, the controller 28 of the device 10[1] turns on the transistor MH of the output stage MM[1] and turns off the transistor ML thereof in response to the rising edge of the clock signal CLK[0]. The controller 28 of the device 10[2] turns on the transistor MH of the output stage MM[2] and turns off the transistor ML thereof in response to the rising edge of the clock signal CLK[1]. The controller 28 of the device 10[3] turns on the transistor MH of the output stage MM[3] and turns off the transistor ML of the output stage MM[3] in response to the rising edge of the clock signal CLK[2]. The controller 28 of the device 10[4] turns on the transistor MH of the output stage MM[4] and turns off the transistor ML of the output stage MM[4] in response to the rising edge of the clock signal CLK[3].

The synchronous output circuit 40[1] generates the clock signal CLK[1] by delaying the phase of the clock signal CLK[0] by a predetermined shift amount SHT[1]. The shift amount SHT[1] is 180 degrees. That is, the synchronous output circuit 40[1] generates the clock signal CLK[1] so that the rising edge of the clock signal CLK[1] occurs at a timing with a phase delay of 180 degrees (i.e., a timing with a time delay of “t_{U1}/2”) from the rising edge of the clock signal CLK[0].

The synchronous output circuit 40[2] generates the clock signal CLK[2] by delaying the phase of the clock signal CLK[1] by a predetermined shift amount SHT[2]. The shift amount SHT[2] is 90 degrees. That is, the synchronous output circuit 40[2] generates the clock signal CLK[2] so that the rising edge of the clock signal CLK[2] occurs at a timing with a phase delay of 90 degrees (i.e., a timing with a time delay of “t_{U1}/4”) from the rising edge of the clock signal CLK[1].

The synchronous output circuit 40[3] generates the clock signal CLK[3] by delaying the phase of the clock signal CLK[2] by a predetermined shift amount SHT[3]. The shift amount SHT[3] is 180 degrees. That is, the synchronous output circuit 40[3] generates the clock signal CLK[3] so that the rising edge of the clock signal CLK[3] occurs at a timing with a phase delay of 180 degrees (i.e., a timing with a time delay of “t_{U1}/2”) from the rising edge of the clock signal CLK[2].

As shown in FIG. 19, multiphase control for four channels can be performed by shifting the phases of the clock signals CLK[0] to CLK[3] from one another.

The arbitrary synchronous output circuit 40[i] determines a shift amount SHT[i] based on shift amount setting information given to the device 10[i]. The external terminal of the device 10[i] may include a dedicated external terminal for specifying the shift amount setting information, and in this case, the synchronous output circuit 40[i] may obtain the shift amount setting information based on a voltage of the dedicated external terminal (a voltage applied from the outside of the device 10[i] to the dedicated external terminal). Alternatively, the shift amount setting information may be stored in a memory (not shown) within the device 10[i]. A host system (not shown) that is connected to the device 10 such that a bidirectional communication can be performed therebetween can write the shift amount setting information in the memory within the device 10.

By the way, the synchronous output terminal S_OUT of the device 10 (10[n]) at the final stage is left open without being connected to the synchronous input terminal S_IN of the other devices 10. Therefore, in the device 10 at the final stage, during the period when the synchronous output terminal S_OUT is in the Hi-Z state (the period P12 in FIG. 12), the voltage of the synchronous output terminal S_OUT may become unstable, and the level detection signal S_{DET} may also have a value of “1” (see FIG. 13). This may lead to an erroneous recognition that a device 10 (virtual device) at a rear stage when viewed from the device 10 at the final stage is outputting a clock signal, even though there is no such virtual device.

Therefore, in the first Example, it is preferable to use a synchronous output circuit 40B of FIG. 20 as the synchronous output circuit 40 of each device 10. The synchronous output circuit 40B has a configuration in which a pull-up resistor 44 is added to the synchronous output circuit 40A of FIG. 8, and is the same as the synchronous output circuit 40A except for such addition. A first end of the pull-up resistor 44 is connected to the application terminal of the power supply voltage VDD and is supplied with the power supply voltage VDD. A second end of the pull-up resistor 44 is connected to the synchronous output terminal S_OUT. In this case, a value of the pull-up resistor 44 is sufficiently larger than the value of the resistor 54 in FIG. 9. For example, when the resistor 54 has a resistance of 50 kΩ (kilo ohms), the value of the pull-up resistor 44 is set to 5 MΩ (mega ohms).

As a result, during the period when the synchronous output terminal S_OUT[i] is in the Hi-Z state, when the synchronous input terminal S_IN[i+1] is in the pull-down state, since the potential of the synchronous output terminal S_OUT[i] is approximately 1/100 of the power supply voltage VDD (is sufficiently lower than the lower threshold voltage V_{THL} of the level detection circuit 60[i]), the level determination circuit 60[i] can reliably determine that a detection target voltage (the voltage of the synchronous output terminal S_OUT[i] at time T3_{PRE}) is at a low level. During the period when the synchronous output terminal S_OUT[i] is in the Hi-Z state, when the synchronous input terminal S_IN[i+1] is in the pull-up state, since the potential of the synchronous output terminal S_OUT[i] matches the power supply voltage VDD, the level determination circuit 60[i] determines that the detection target voltage (the voltage of the synchronous output terminal S_OUT[i] at time T3_{PRE}) is at a high level.

Regarding the device 10[n] at the final stage, during the period when the synchronous output terminal S_OUT[n] is in the Hi-Z state, the level of the synchronous output terminal S_OUT[i] is maintained at the power supply voltage VDD due to presence of the pull-up resistor 44, and, as a result, the level determination circuit 60[n] determines that the detection target voltage (the voltage of the synchronous output terminal S_OUT[n] at time T3_{PRE}) is at a high level, and outputs the level detection signal S_{DET} of “0.” Therefore, the above-mentioned erroneous recognition does not occur.

The value of the pull-up resistor 44 is much larger than the on-resistance value of the transistor 41 and the on-resistance value of the transistor 42. Therefore, also in the synchronous output circuit 40B, the output impedance of the synchronous output terminal S_OUT in the Hi-Z state is sufficiently higher than the output impedance in the low level output state and the output impedance in the high level output state, as in the synchronous output circuit 40A. It can be said that the synchronous output circuit 40B as the synchronous output circuit 40[i] outputs a high-level signal from the synchronous output terminal S_OUT[i] with a higher output impedance in the Hi-Z state than in the high level output state.

### Second Example

A second example will be described. The second example and third to seventh examples to be described later are examples based on the first example, and unless contradictory, regarding matters not specifically stated in the second to seventh examples, the description in the first example may also be applied to the second to seventh examples. However, in interpreting the description of the second example, regarding matters that are inconsistent between the first and second examples, the description of the second example may take precedence (the same applies to the third to seventh examples to be described later). Any plurality of examples among the first to seventh examples may be combined unless contradictory.

In the second example, it is assumed that the synchronous input terminal S_IN of the device 10 [1] is open, as in the first example. Therefore, in the second example, the controller 28 of the device 10[1] performs the switching control of the output stage MM[1] by using the internal clock signal CLK_{A} generated within the device 10[1], as the reference clock signal CLK_{REF}.

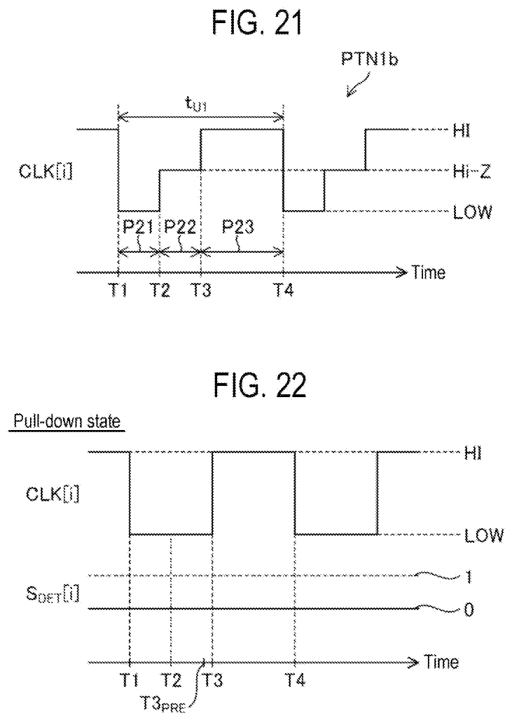

FIG. 21 shows a conceptual waveform diagram of the clock signal CLK[i] according to the second example. In the second example, each cycle of any clock signal is considered to start from a falling edge of the clock signal. The synchronous output circuit 40[i] according to the second example switches the state of the synchronous output terminal S_OUT[i] from the high level output state to the low level output state at time T1, then switches the low level output state to the Hi-Z state at time T2, then switches from the Hi-Z state to the high level output state at time T3, and then switches from the high level output state to the low level output state at time T4. Thereafter, the same operations are repeated. When time T1 is the start time of the j-th cycle of the clock signal CLK[i], time T4 corresponds to the start time of the (j+1)-th cycle of the clock signal CLK[i]. In this case, j represents any natural number.

As described above, the synchronous output circuit 40[i] according to the second example includes a period P21 (between times T1 and T2 in FIG. 21) during which the state of the synchronous output terminal S_OUT[i] is set to the low level output state, a period P23 (between times T3 and T4 in FIG. 21) during which the state of the synchronous output terminal S_OUT[i] is set to the high level output state, and a period P22 (between times T2 and T3 in FIG. 21) during which the state of the synchronous output terminal S_OUT[i] is set to the Hi-Z state, in each cycle of the clock signal CLK[i] during the output period of the clock signal CLK[i]. For example, lengths of the periods P21, P22, and P23 are 25%, 25%, and 50% of the unit time t_{U1}, respectively. However, proportions of the periods P21, P22, and P23 in the unit time t_{U1} may be arbitrary. An output pattern of the clock signal CLK[i]according to the second example is referred to as a pattern PTN1b.

FIG. 22 shows a waveform of the clock signal CLK[i] when the synchronous input circuit 50[i+1] is in the pull-down state. When the synchronous input circuit 50[i+1] is in the pull-down state, the potential of the clock signal CLK[i] is maintained at the ground potential (therefore, maintained at a low level) after time T2, via time T3_{PRE}, and until time T3, and the potential of the clock signal CLK[i] sharply rises from the ground potential to the potential of the power supply voltage VDD with time T3 as a boundary.

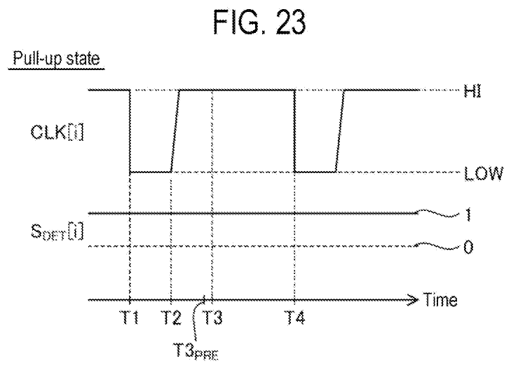

FIG. 23 shows a waveform of the clock signal CLK[i] when the synchronous input circuit 50[i+1] is in the pull-up state. When the synchronous input circuit 50[i+1] is in the pull-up state, since the potential of the clock signal CLK[i] rises from the ground potential toward the potential of the power supply voltage VDD after time T2 and rises up to the potential of the power supply voltage VDD before time T3_{PRE}, the synchronous output terminal S_OUT[i] at time T3_{PRE} has a high level.

Similar to the first example, when the clock signal CLK[i] is output by the synchronous output circuit 40[i], the level detection circuit 60[i] specifies the voltage of the synchronous output terminal S_OUT[i] at time T3_{PRE} as a detection target voltage and detects which one of a high level or a low level the detection target voltage belongs to.

However, when the level detection circuit 60[i] according to the second example determines that the detection target voltage belongs to the high level, it outputs the level detection signal S_{DET}[i] of “1” (see FIG. 23). When the level detection signal S_{DET}[i] of “1” is output, “S_{DET}[i]=1” is maintained thereafter until it is determined that the detection target voltage belongs to the low level. When the level detection circuit 60[i] according to the second example determines that the detection target voltage belongs to the low level, it outputs the level detection signal S_{DET}[i] of “0” (see FIG. 22). When the level detection signal S_{DET}[i] of “0” is output, “S_{DET}[i]=0” is maintained thereafter until it is determined that the detection target voltage belongs to the high level.

In the second example, a falling edge always occurs in the clock signal CLK[i] at time T1 regardless of the state of the synchronous input circuit 50[i+1]. Therefore, by using the falling edge of the clock signal CLK[i], switching can be synchronized between the devices 10[i] and 10[i+1]. In order to ensure this synchronization, in the second example in which the pattern PTN1b of FIG. 21 is employed, the set edge is a falling edge. That is, when the clock signal CLK[i] of the pattern PTN1b is supplied to the device 10[i+1], the controller 28 of the device 10[i+1] turns on the transistor MH and turns off the transistor ML in response to the falling edge of the clock signal CLK[i].

In the second example, the following second rule is adopted in each device 10. In the second rule, the relationship between the pull-down state and the pull-up state is opposite to that in the first rule. In other words, the device 10[i] according to the second rule sets the state of the synchronous input terminal S_IN[i] to the pull-up state during the output period of the clock signal CLK[i], while setting the state of the synchronous input terminal S_IN[i] to the pull-down state during the non-output period of the clock signal CLK[i].

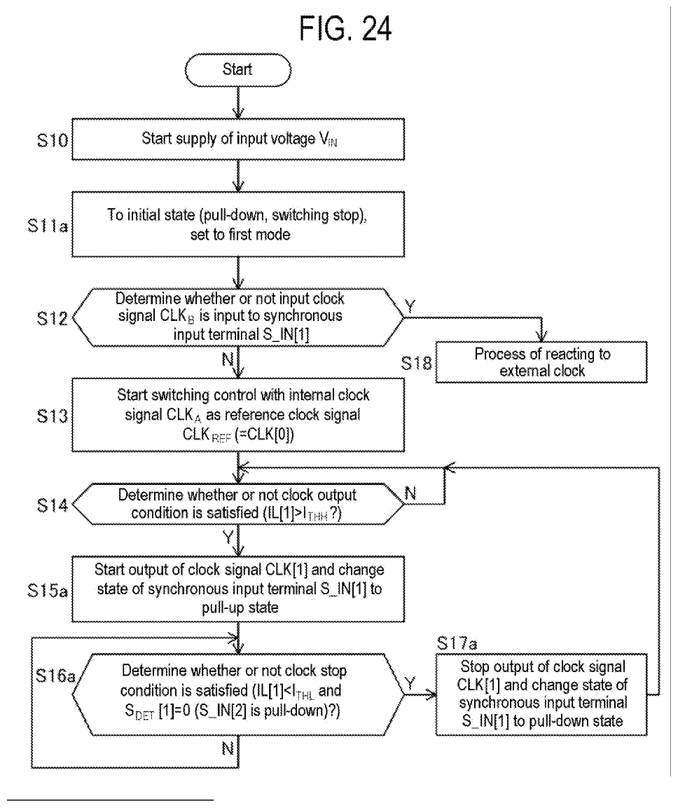

FIG. 24 shows an operation flowchart of the device 10[1] operating in the first mode. In the second example, the operation of the device 10[1] is the same as the processing in steps S10 to S18 shown in FIG. 17, except for the following differences. That is, in the second example, steps S11, S15, S16, and S17 are replaced with steps S11a, S15a, S16a, and S17a, respectively.

In step S11a, the synchronous input terminal S_IN[1] is set to the pull-down state. Step S11a is similar to step S11 in other respects. In step S15a, the state of the synchronous input terminal S_IN[1] is changed from the pull-down state to the pull-up state. Step S15a is similar to step S15 in other respects. Processing content itself of step S16a is the same as that of step S16. However, in the second example, “S_{DET}[1]=0” indicates that the synchronous input terminal S_IN[2] is in the pull-down state (see FIG. 22). In step S17a, the state of the synchronous input terminal S_IN[1] is changed from the pull-up state to the pull-down state. Step S17a is similar to step S17 in other respects.

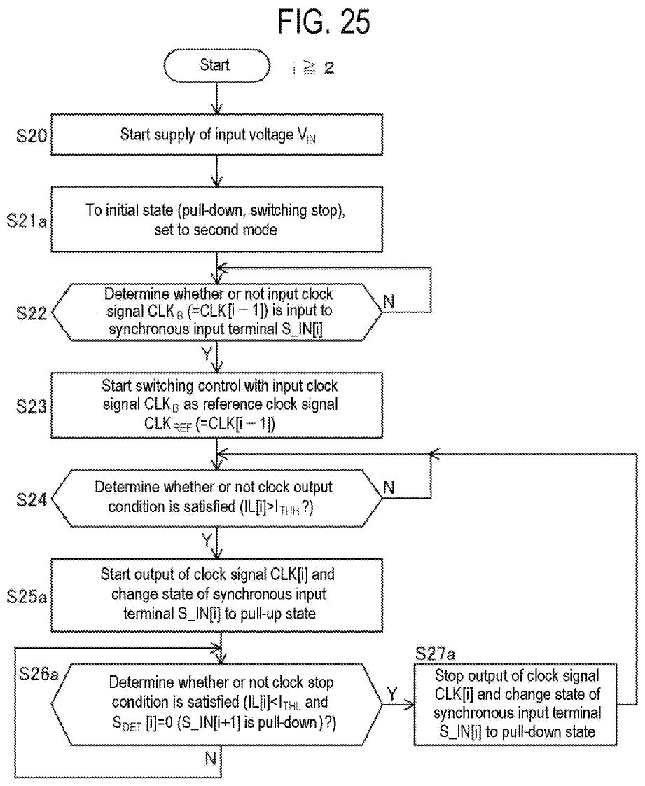

FIG. 25 shows an operation flowchart of the device 10[i] operating in the second mode. A variable i in each step shown in FIG. 25 represents an arbitrary integer of 2 or more. In the second example, the operation of the device 10[i] is the same as the processing in steps S20 to S27 shown in FIG. 18, except for the following differences. That is, in the second example, steps S21, S25, S26, and S27 are replaced with steps S21a, S25a, S26a, and S27a, respectively.

In step S21a, the synchronous input terminal S_IN[i] is set to the pull-down state. Step S21a is similar to step S21 in other respects. In step S25a, the state of the synchronous input terminal S_IN[i] is changed from the pull-down state to the pull-up state. Step S25a is similar to step S25 in other respects. The processing content itself of step S26a is the same as that of step S26. However, in the second example, “S_{DET}[i]=0” indicates that the synchronous input terminal S_IN[i+1] is in the pull-down state (see FIG. 22). In step S27a, the state of the synchronous input terminal S_IN[i] is changed from the pull-up state to the pull-down state. Step S27a is similar to step S27 in other respects.

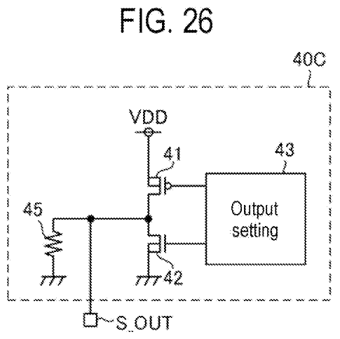

In the second example, it is preferable to use a synchronous output circuit 40C of FIG. 26 as the synchronous output circuit 40 of each device 10. The synchronous output circuit 40C has a configuration in which a pull-down resistor 45 is added to the synchronous output circuit 40A of FIG. 8, and is the same as the synchronous output circuit 40A except for such addition. A first end of the pull-down resistor 45 is connected to the ground, and a second end of the pull-down resistor 45 is connected to the synchronous output terminal S_OUT. In this case, a value of the pull-down resistor 45 is sufficiently larger than the value of the resistor 54 in FIG. 9. For example, when the resistor 54 has a resistance of 50 kΩ (kilo ohms), the value of the pull-down resistor 45 is set to 5 MΩ (mega ohms).

As a result, during the period when the synchronous output terminal S_OUT[i] is in the Hi-Z state, when the synchronous input terminal S_IN[i+1] is in the pull-up state, since the potential of the synchronous output terminal S_OUT[i] is approximately 99/100 of the power supply voltage VDD (sufficiently higher than the upper threshold voltage V_{THH} of the level detection circuit 60[i]), the level determination circuit 60[i] can reliably determine that a detection target voltage (a voltage of the synchronous output terminal S_OUT[i] at time T3_{PRE}) is at a high level. During the period when the synchronous output terminal S_OUT[i] is in the Hi-Z state, when the synchronous input terminal S_IN[i+1] is in the pull-down state, since the potential of the synchronous output terminal S_OUT[i] matches the ground potential, the level determination circuit 60[i] determines that the detection target voltage (the voltage of the synchronous output terminal S_OUT[i] at time T3_{PRE}) is at a low level.

Regarding the device 10[n] at the final stage, during the period when the synchronous output terminal S_OUT[n] is in the Hi-Z state, the potential of the synchronous output terminal S_OUT[i] is maintained at the ground potential due to presence of the pull-down resistor 45, and, as a result, the level determination circuit 60[n] determines that the detection target voltage (the voltage of the synchronous output terminal S_OUT[n] at time T3_{PRE}) is at a low level. In other words, the erroneous recognition described in the first example does not occur.

The value of the pull-down resistor 45 is much larger than the on-resistance value of the transistor 41 and the on-resistance value of the transistor 42. Therefore, also in the synchronous output circuit 40C, the output impedance of the synchronous output terminal S_OUT in the Hi-Z state is sufficiently higher than the output impedance in the low level output state and the output impedance in the high level output state, as in the synchronous output circuit 40A. It can be said that the synchronous output circuit 40C as the synchronous output circuit 40[i] outputs a low-level signal from the synchronous output terminal S_OUT[i] with a higher output impedance in the Hi-Z state than in the low level output state.

The waveforms of the clock signals CLK[0] to CLK[3] in the 4-channel drive state are similar to those shown in FIG. 19. However, in the second example, since the falling edge of the clock signal functions as a set edge for the controller 28, the timing of the falling edge of the clock signal CLK[i+1] is determined based on the timing of the falling edge of the clock signal CLK[i]. That is, the synchronous output circuit 40[1] generates the clock signal CLK[1] such that the falling edge of the clock signal CLK[1] occurs at a timing with a phase delay of 180 degrees (i.e., a timing with a time delay of “t_{U1}/2”) from the falling edge of the clock signal CLK[0]. Similarly, the synchronous output circuit 40[2] generates the clock signal CLK[2] such that the falling edge of the clock signal CLK[2] occurs at a timing with a phase delay of 90 degrees (i.e., a timing with a time delay of “t_{U1}/4”) from the falling edge of the clock signal CLK[0]. Similarly, the synchronous output circuit 40[3] generates the clock signal CLK[3] such that the falling edge of the clock signal CLK[3] occurs at a timing with a phase delay of 180 degrees (i.e., a timing with a time delay of “t_{U1}/2”) from the falling edge of the clock signal CLK[0].

### Third Example

A third example will be described. In the first example, the pattern PTN1a shown in FIG. 12 and the first rule are combined. As already mentioned, the device 10[i] according to the first rule sets the state of the synchronous input terminal S_IN[i] to the pull-down state during the output period of the clock signal CLK[i], while setting the state of the synchronous input terminal S_IN[i] to the pull-up state during the non-output period of the clock signal CLK[i]. In the second example, the pattern PTN1b shown in FIG. 21 and the second rule are combined. As already mentioned, the device 10[i] according to the second rule sets the state of the synchronous input terminal S_IN[i] to the pull-up state during the output period of the clock signal CLK[i], while setting the state of the synchronous input terminal S_IN[i] to the pull-down state during the non-output period of the clock signal CLK[i].

However, a first modified configuration in which the pattern PTN1a in FIG. 12 and the second rule are combined may be adopted. In the first modified configuration, in accordance with the adoption of the second rule, it is possible to use the synchronous output circuit 40C of FIG. 26 as the synchronous output circuit 40 of each device 10. However, when the synchronous output circuit 40C is used in the first modified configuration, due to influence of a parasitic capacitance added to the synchronous output terminal S_OUT[n] at the final stage, a slope of a potential drop of the synchronous output terminal S_OUT[n] from time T2 in FIG. 12 becomes smaller and, as a result, the potential of the synchronous output terminal S_OUT[n] at time T3_{PRE} in FIG. 12, which should originally be determined to belong to a low level, may be determined to belong to a high level. Therefore, it is desirable to adopt the first rule for the pattern PTN1a.

Similarly, a second modified configuration in which the pattern PTN1b in FIG. 21 and the first rule are combined may be adopted. In the second modified configuration, in accordance with the adoption of the first rule, it is possible to use the synchronous output circuit 40B of FIG. 20 as the synchronous output circuit 40 of each device 10. However, when the synchronous output circuit 40B is used in the second modified configuration, due to influence of a parasitic capacitance added to the synchronous output terminal S_OUT[n] at the final stage, the slope of the potential rise of the synchronous output terminal S_OUT[n] from time T2 in FIG. 21 becomes smaller and, as a result, the potential of the synchronous output terminal S_OUT[n] at time T3_{PRE} in FIG. 21, which should originally be determined to belong to a high level, may be determined to belong to a low level. Therefore, it is desirable to adopt the second rule for the pattern PTN1b.

In the first example or the second example, the output pattern of the clock signal CLK[i] by the synchronous output circuit 40[i] is not limited to the pattern PTN1a or PTN1b. That is, in the first example or the second example, the output pattern of the clock signal CLK[i] may be arbitrary as long as each cycle of the clock signal CLK[i] includes a period in which the state of the synchronous output terminal S_OUT[i] is set to the high level output state, a period in which the state of the synchronous output terminal S_OUT[i] is set to the low level output state, and a period in which the state of the synchronous output terminal S_OUT[i] is set to the Hi-Z state. However, in consideration of ease of performing various controls, determinations and the like, it is preferable to adopt the pattern PTN1a or PTN1b.

### Fourth Example

A fourth example will be described. In the first example or the second example, it is assumed that the clock signal CLK_{B} is not input to the synchronous input terminal S_IN[1]. However, in the first example or the second example, when the clock signal CLK_{B} is input from an external clock supply circuit (not shown) to the synchronous input terminal S_IN[1] of the device 10[1], in step S18 (see FIG. 17 or 24), the input clock signal CLK_{B} to the synchronous input terminal S_IN[1] may be set to the clock signal CLK[0] (the reference clock signal CLK_{REF} of the device 10[1]). In this case, after the process proceeds from step S18 to step S13, the device 10[1] starts the switching control of the output stage MM[1] in synchronization with the clock signal CLK[0] which is the input clock signal CLK_{B} to the synchronous input terminal S_IN[1].

### Fifth Example

A fifth example will be described. A synchronization timing can be notified from the device 10[i] at the front stage to the device 10[i+1] at the rear stage by the above-described clock signal CLK[i]. In the fifth example, a method will be described in which information other than the synchronization timing is transmitted from the device 10[i] at the front stage to the device 10[i+1] at the rear stage by using the clock signal CLK[i].

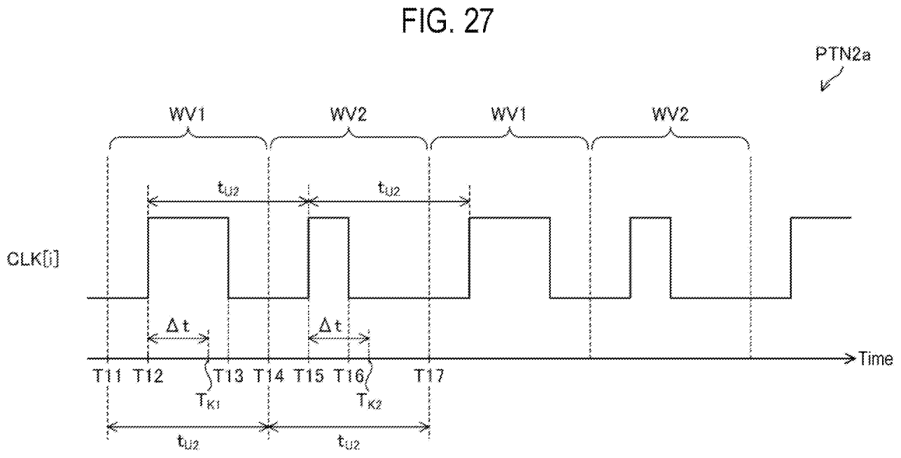

In each device 10, the synchronous output circuit 40 may output the clock signal CLK[i] of a pattern PTN2a in FIG. 27. The pattern PTN2a will be described. As time progresses, times T11, T12, T13, T14, T15, T16, and T17 arrive in this order. A time difference between times T11 and T14 matches unit time t_{U2}, and a time difference between times T14 and T17 also matches the unit time t_{U2}. A time difference between times T11 and T12 and a time difference between times T15 and T16 both match time (t_{U2}/4), but may be slightly different from time (t_{U2}/4). A time difference between times T12 and T13, a time difference between times T13 and T15, and a time difference between times T16 and T17 all match time (t_{U2}/2), but may be slightly different from time (t_{U2}/2). However, in the clock signal CLK[i] of the pattern PTN2a, an interval between two adjacent rising edges is constant and matches the unit time t_{U2}.

In the pattern PTN2a, the state of the synchronous output terminal S_OUT[i] is the low level output state at time T11, then switches from the low level output state to the high level output state at time T12, then switches from the high level output state to the low level output state at time T13, then switches from the low level output state to the high level output state at time T15, then switches from the high level output state to the low level output state at time T16, and then is maintained at the low level output state until time T17.

One cycle of the clock signal CLK[i] of the pattern PTN2a corresponds to a period between times T11 and T17. In the pattern PTN2a, in a case where the period between times T11 and T17 is the j-th period of the clock signal CLK[i], then a period of time (2×t_{U2}) from time T17 is the (j+1)-th period of the clock signal CLK[i]. In this case, j represents any natural number. The waveform of the clock signal CLK[i] is the same in each cycle of the clock signal CLK[i] of the pattern PTN2a.

In the pattern PTN2a, waveforms WV1 and WV2 appear alternately in the clock signal CLK[i]. When the period between times T11 and T17 is focused on, the waveform WV1 is the waveform of the clock signal CLK[i] between times T11 and T14, and the waveform WV2 is the waveform of the clock signal CLK[i] between times T14 and T17.

As described above, the synchronous output circuit 40[i] alternately sets the state of the synchronous output terminal S_OUT[i] to the low level output state and the high level output state during the output period of the clock signal CLK[i] of the pattern PTN2a and does not set the state of the synchronous output terminal S_OUT[i] to the Hi-Z state. In this case, the unit time t_{U2} may be the same as the unit time t_{U1}, or may be approximately the same as the unit time t_{U1} (see FIG. 12). In this case, it is assumed that “t_{U2}=t_{U1}.”

The pattern determination circuit 70[i] in the arbitrary device 10[i] determines whether or not the clock signal of the pattern PTN2a is input to the synchronous input terminal S_IN[i], based on the voltage of the synchronous input terminal S_IN[i], and outputs a pattern determination signal S_{PTN}[i] indicating a result of the determination. The pattern determination circuit 70[i] outputs the pattern determination signal S_{PTN}[i] having a value of “1” only when determining that the clock signal of the pattern PTN2a is input to the synchronous input terminal S_IN[i] and, in other cases, outputs the pattern determination signal S_{PTN}[i] having a value of “0.”

The pattern determination circuit 70[i] performs the above-mentioned determination based on the voltage of the synchronous input terminal S_IN[i] at determination times T_{K1} and T_{K2}. Determination time T_{K1} is a time after a predetermined time Δt after a rising edge occurs in the signal of the synchronous input terminal S_IN[i], and determination time T_{K2} is a time after a predetermined time Δt after the next rising edge occurs in the signal of the synchronous input terminal S_IN[i]. In FIG. 27, determination time T_{K1} is a time after time T12 by the predetermined time Δt, and determination time T_{K2} is a time after time T15 by the predetermined time Δt. In FIG. 27, determination time T_{K1} is later than a time after time T12 by a time (t_{U2}/4) and earlier time T13. In FIG. 27, determination time T_{K2} is later than time T16 and earlier than a time after time T16 by a time (t_{U2}/8). For example, the predetermined time Δt is (3/8) times the unit time t_{U2}.

When the clock signal CLK[i] of the pattern PTN2a shown in FIG. 27 is output from the device 10[i], it is the device 10[i+1] that receives the clock signal CLK[i] (see FIG. 11). Therefore, for the sake of convenience of description, an operation of the pattern determination circuit 70[i+1] will be described in detail with reference to FIG. 27 (also see FIG. 11). Since the output impedance of the synchronous output circuit 40[i] during the output period of the clock signal CLK[i] of the pattern PTN2a is sufficiently smaller than the input impedance of the synchronous input circuit 50[i+1] (corresponding to the value of the resistor 54 in FIG. 9), the voltage of the synchronous input terminal S_IN[i+1] does not substantially depend on the state of the synchronous input circuit 50[i+1].

The pattern determination circuit 70[i+1] determines whether or not the clock signal CLK[i] has the pattern PTN2a by determining whether or not the clock signal CLK[i] has a waveform that switches between the waveforms WV1 and WV2, based on the voltage of the synchronous input terminal S_IN[i+1]. More specifically, when the signal level of the synchronous input terminal S_IN[i+1] changes between a high level and a low level, the pattern determination circuit 70[i+1] extracts two consecutive rising edges in the signal of the synchronous input terminal S_IN[i+1] as first and second rising edges. Then, the pattern determination circuit 70[i+1] specifies the level of the synchronous input terminal S_IN[i+1] at a time after a predetermined time Δt from the first rising edge and the level of the synchronous input terminal S_IN[i+1] at a time after a predetermined time Δt from the second rising edge. The pattern determination circuit 70[i+1] determines that the clock signal of the pattern PTN2a is input to the synchronous input terminal S_IN[i+1] only when one of the two specified levels is a high level and the other is a low level, and outputs the pattern determination signal S_{PTN}[i+1] of “1” and, otherwise, outputs the pattern determination signal S_{PTN}[i] having a value of “0.” One of the time after the predetermined time Δt from the first rising edge and the time after the predetermined time Δt from the second rising edge is determination time T_{K1} and the other is determination time T_{K2}.

The synchronous output circuit 40[i] according to the fifth example can selectively output the clock signal CLK[i] of the pattern PTN2a and the clock signal CLK[i] of the pattern PTN1a shown in FIG. 12.

When the synchronous input terminal S_IN[i+1] is set to the pull-up state by the synchronous input circuit 50[i+1], in a case where the clock signal CLK[i] of the pattern PTN2a consists of only the waveform WV1, a signal waveform appearing at the synchronous input terminal S_IN[i+1] hardly differs between when the clock signal CLK[i] has the pattern PTN2a and when the clock signal CLK[i] has the pattern PTN1a. Similarly, when the synchronous input terminal S_IN[i+1] is set to the pull-down state by the synchronous input circuit 50[i+1], in a case where the clock signal CLK[i] of the pattern PTN2a consists of only the waveform WV2, the signal waveform appearing at the synchronization input terminal S_IN[i+1] hardly differs between when the clock signal CLK[i] has the pattern PTN2a and when the clock signal CLK[i] has the pattern PTN1a. Therefore, in practice, as shown in FIG. 27, the clock signal CLK[i] of the pattern PTN2a includes the waveforms WV1 and WV2.

In a case where the clock signal CLK[i] has the pattern PTN1a, when the synchronous input terminal S_IN[i+1] is set to the pull-up state, after a predetermined time Δt from the rising edge of the signal of the synchronous input terminal S_IN[i+1], since the signal of the synchronous input terminal S_IN[i+1] always has a high level, the pattern determination signal S_{PTN}[i+1] becomes “0.” Similarly, in a case where the clock signal CLK[i] has the pattern PTN1a, when the synchronous input terminal S_IN[i+1] is set to the pull-down state, after a predetermined time Δt from the rising edge of the signal of the synchronous input terminal S_IN[i+1], since the signal of the synchronous input terminal S_IN[i+1] always has a low level, the pattern determination signal S_{PTN}[i+1] becomes “0.”

On the other hand, when the clock signal CLK[i] has the pattern PTN2a, since one of the levels of the synchronous input terminal S_IN[i+1] at the two determination times T_{K1} and T_{K2} is a high level and the other is a low level regardless of the state of the synchronous input terminal S_IN[i+1], the pattern determination signal S_{PTN}[i+1] of “1” is generated. Therefore, the pattern determination signal S_{PTN}[i+1] of “1” indicates that the clock signal CLK[i] input to the synchronous input terminal S_IN[i+1] has the pattern PTN2a.

It is possible to forcibly perform switching control on all channels by using the clock signal CLK[i] having the pattern PTN2a, which will be described in detail.

A forced output determination circuit in the device 10 [1] operating in the first mode determines whether or not a predetermined forced output condition is satisfied. In this case, it is assumed that the forced output condition is satisfied when a clock signal with a predetermined duty is input to the synchronous input terminal S_IN[1] and the forced output condition is not satisfied when a clock signal with a predetermined duty is not input to the synchronous input terminal S_IN[1]. In this case, the forced output determination circuit may be the pattern determination circuit 70[1] or the switching control circuit 20[1]. The predetermined duty is a duty within a certain range and in this case, as an example, it is assumed that the predetermined duty is 40% or more and 60% or less. The duty of a certain clock signal refers to a ratio of a high level period of a relevant clock signal to a sum of the high level period and a low level period of the relevant clock signal.

Alternatively, forced output setting information may be stored in a memory (not shown) in the device 10[1]. At this time, the forced output condition is satisfied when the forced output setting information in the memory is “1,” and the forced output condition is not satisfied when the forced output setting information in the memory is “0.” A host system (not shown) that is connected to the device 10[1] such that a bidirectional communication is capable of being performed therebetween can write “1” or “0” in the forced output setting information in the memory within the device 10[1].

The fifth example can be implemented in combination with the first example, as will be described below. In the fifth example, the first rule described in the first example is adopted, and the set edge is a rising edge. That is, the controller 28 of the device 10[i+1] turns on the transistor MH and turns off the transistor ML in response to the rising edge of the clock signal CLK[i]. In the fifth example combined with the first example, it is preferable to use the synchronous output circuit 40B of FIG. 20 as the synchronous output circuit 40 of each device 10.

A situation FORCE_ON is considered in which the clock signal CLK_{B} having a duty of 50% is input from an external clock supply circuit (not shown) to the synchronous input terminal S_IN[1] of the device 10[1] after the device 10[1] is activated. In this case, the forced output condition is satisfied. In the situation FORCE_ON, the input clock signal CLK_{B} to the synchronous input terminal S_IN[1] is input, as the reference clock signal CLK_{REF}, to the controller 28 of the device 10[1]. For the sake of convenience of description, the reference clock signal CLK_{REF} supplied to the controller 28 of the device 10[1] may be referred to as a clock signal CLK[0]. In the situation FORCE_ON, the output stage MM[1] is switched in synchronization with the clock signal CLK[0]. That is, in response to the rising edge of the clock signal CLK[0] which is the input clock signal CLK_{B}, the transistor MH of the output stage MM[1] is turned on and the transistor ML thereof is turned off.

When switching control is performed in the device 10[1] in the situation FORCE_ON, the clock management circuit 80[1] controls the synchronous output circuit 40[1] to cause the synchronous output circuit 40[1] to output the clock signal CLK[1] having the pattern PTN2a from the synchronous output terminal S_OUT[1] regardless of whether or not the clock output condition (clock output condition in step S14 in FIG. 17) is satisfied. The clock signal CLK[1] having the pattern PTN2a is generated based on the reference clock signal CLK_{REF} (i.e., the clock signal CLK[0]) of the device 10[1].

When the clock signal CLK[1] having the pattern PTN2a is input to the synchronous input terminal S_IN[2], the clock signal CLK[1] having the pattern PTN2a is input to the controller 28 of the device 10[2], as the reference clock signal CLK_{REF} of the device 10[2]. Therefore, the output stage MM[2] is switched in synchronization with the clock signal CLK[1]. That is, in response to the rising edge of the clock signal CLK[1] having the pattern PTN2a, the transistor MH of the output stage MM[2] is turned on and the transistor ML thereof is turned off.

Further, when the clock signal CLK[1] having the pattern PTN2a is input to the synchronous input terminal S_IN[2], the pattern determination signal S_{PTN}[2] has a value of “1.” When “S_{PTN}[2]=1”, the clock management circuit 80[2] controls the synchronous output circuit 40[2] to cause the synchronous output circuit 40[2] to output the clock signal CLK[2] having the pattern PTN2a from the synchronous output terminal S_OUT[2] regardless of whether or not the clock output condition (clock output condition in step S24 in FIG. 18) is satisfied. The clock signal CLK[2] having the pattern PTN2a is generated based on the reference clock signal CLK_{REF} of the device 10[2] (i.e., an input clock signal CLK[1] to the device 10[2]).

Operations of other devices 10 (for example, the device 10[3]) operating in the second mode are similar to the operation of the device 10[2]. That is, for example, when the clock signal CLK[2] having the pattern PTN2a is input to the synchronous input terminal S_IN[3], the clock signal CLK[2] having the pattern PTN2a is input to the controller 28 of the device 10[3], as the reference clock signal CLK_{REF} of the device 10[3]. Therefore, the output stage MM[3] is switched in synchronization with the clock signal CLK[2]. That is, in response to the rising edge of the clock signal CLK[2] having the pattern PTN2a, the transistor MH of the output stage MM[3] is turned on and the transistor ML thereof is turned off.

Further, when the clock signal CLK[2] having the pattern PTN2a is input to the synchronous input terminal S_IN[3], the pattern determination signal S_{PTN}[3] has a value of “1.” When “S_{PTN}[3]=1,” the clock management circuit 80[3] controls the synchronous output circuit 40[3] to cause the synchronous output circuit 40[3] to output the clock signal CLK[3] having the pattern PTN2a from the synchronous output terminal S_OUT[3] regardless of whether or not the clock output condition (clock output condition in step S24 in FIG. 18) is satisfied. The clock signal CLK[3] having the pattern PTN2a is generated based on the reference clock signal CLK_{REF} of the device 10[3] (i.e., an input clock signal CLK[2] to the device 10[3]).

The same applies to the devices 10[4] to 10[n]. Therefore, in the situation FORCE_ON, switching control is performed in the devices 10 of all channels, regardless of whether or not the clock output condition is satisfied.

The operation of the device 10[1] when the forced output condition is not satisfied is the same as that shown in FIG. 17, and the operation of each of the devices 10[2] to 10[n] when the forced output condition is not satisfied is the same as that shown in FIG. 18. However, the clock signal CLK[i] that can be output from the device 10[i] when the forced output condition is not satisfied has the same pattern PTN1a as in the first example. Therefore, in a case where the forced output condition is not satisfied, when the clock signal CLK[1] is not supplied to the synchronous input terminal S_IN[2], the synchronous output circuit 40[2] of the device 10[2] does not output any clock signal (keeps the synchronous output terminal S_OUT [2] in the Hi-Z state). In a case where the forced output condition is not satisfied, when the clock signal CLK[1] of the pattern PTN1a is supplied to the synchronous input terminal S_IN[2], the device 10[2] performs switching control in synchronization with the clock signal CLK[1]. When the clock output condition is satisfied in the device 10[2], the clock signal CLK[2] of the pattern PTN1a based on the clock signal CLK[1] (the input clock signal CLK[1] to the device 10[2]) is output from the synchronous output terminal S_OUT[2] by the synchronous output circuit 40[2]. The same applies to other devices 10 (for example, the device 10[3]) that operate in the second mode.

In the device 10[1] operating in the first mode, when the forced output condition is not satisfied, after the synchronous output circuit 40[1] starts the output of the clock signal CLK[1] of the pattern PTN1a, the output of the clock signal CLK[1] of the pattern PTN1a is stopped in response to the establishment of the clock stop condition (the clock stop condition in step S16 in FIG. 17).

When the forced output condition is not satisfied, the clock signal CLK[1] of the pattern PTN1a may be supplied to the synchronous input terminal S_IN[2]. In the device 10[2] operating in the second mode, when the clock signal CLK[1] of the pattern PTN1a is supplied to the synchronous input terminal S_IN[2], after the synchronous output circuit 40[2] starts the output of the clock signal CLK[2] of the pattern PTN1a, the output of the clock signal CLK[2] of the pattern PTN1a is stopped in response to the establishment of the clock stop condition (the clock stop condition in step S26 in FIG. 18). The same applies to other devices 10 (for example, the device 10[3]) that operate in the second mode.

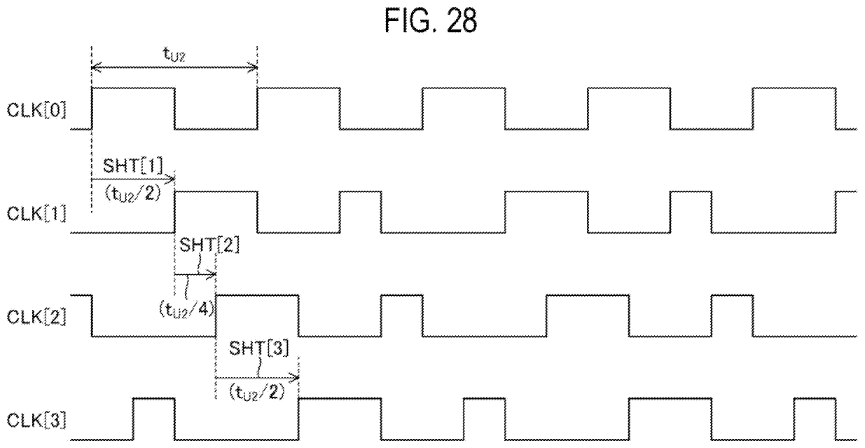

FIG. 28 shows waveforms of the clock signals CLK[0] to CLK[3] in the 4-channel drive state under the situation FORCE_ON. Under the situation FORCE_ON, the clock signal CLK[0] supplied to the device 10[1] from an external clock supply circuit (not shown) is a rectangular wave signal with a duty of 50%, and a length of one cycle of the clock signal CLK[0] is unit time t_{U2}.

In the 4-channel drive state related to the situation FORCE_ON, the clock signals CLK[0] to CLK[3] are the reference clock signals CLK_{REF} in the devices 10[1] to 10[4], respectively. Therefore, the controller 28 of the device 10[1] turns on the transistor MH of the output stage MM[1] and turns off the transistor ML thereof in response to the rising edge of the clock signal CLK[0]. The controller 28 of the device 10[2] turns on the transistor MH of the output stage MM[2] and turns off the transistor ML thereof in response to the rising edge of the clock signal CLK[1]. The controller 28 of the device 10[3] turns on the transistor MH of the output stage MM[3] and turns off the transistor ML thereof in response to the rising edge of the clock signal CLK[2]. The controller 28 of the device 10[4] turns on the transistor MH of the output stage MM[4] and turns off the transistor ML thereof in response to the rising edge of the clock signal CLK[3].

In the situation FORCE_ON, the synchronous output circuit 40[1] generates the clock signal CLK[1] based on the clock signal CLK[0]. At this time, the synchronous output circuit 40[1] generates the clock signal CLK[1] so that a time delayed by the shift amount SHT[1] from the time when the rising edge of the clock signal CLK[0] occurs becomes time T12 for the clock signal CLK[1] (see also FIG. 27).

In the situation FORCE_ON, the synchronous output circuit 40[2] generates the clock signal CLK[2] based on the clock signal CLK[1]. At this time, the synchronous output circuit 40[2] generates the clock signal CLK[2] so that a time delayed by the shift amount SHT[2] from the time when the rising edge of the clock signal CLK[1] occurs becomes time T12 for the clock signal CLK[2] (see also FIG. 27).

In the situation FORCE_ON, the synchronous output circuit 40[3] generates the clock signal CLK[3] based on the clock signal CLK[2]. At this time, the synchronous output circuit 40[3] generates the clock signal CLK[3] so that a time delayed by the shift amount SHT[3] from the time when the rising edge of the clock signal CLK[2] occurs becomes time T12 for the clock signal CLK[3] (see also FIG. 27).

The shift amounts SHT[1], SHT[2], and SHT[3] correspond to time (t_{U2}/2), time (t_{U2}/4), and time (t_{U2}/2), respectively. As a result, since the phases of the clock signals CLK[0] to CLK[3] are shifted from one another (the rising edge timings of the clock signals CLK[0] to CLK[3] are shifted from one another), multiphase control for four channels is performed.

### Sixth Example

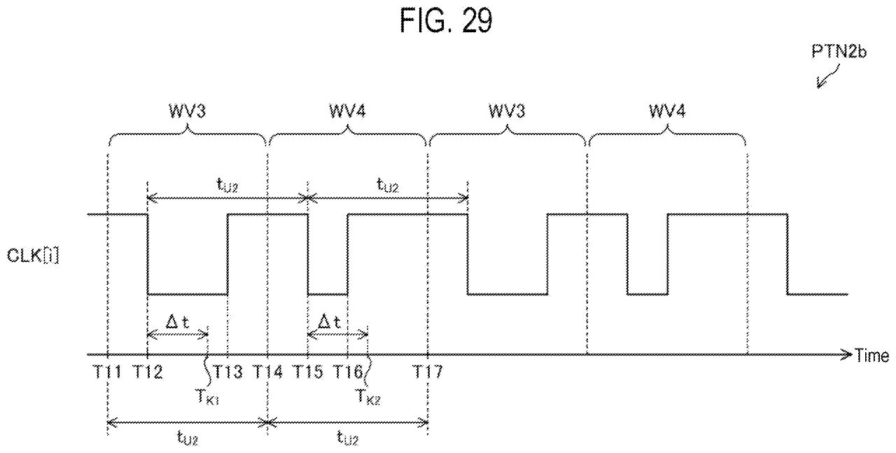

A sixth example will be described. The fifth example may be modified in the same manner as the case where the first example is changed to the second example. That is, in each device 10 according to the sixth example, the synchronous output circuit 40 may be capable of outputting the clock signal CLK[i] of a pattern PTN2b in FIG. 29. The clock signal CLK[i] of the pattern PTN2b corresponds to an inversion of the clock signal CLK[i] of the pattern PTN2a according to the fifth example. The sixth example is a partial modification of the fifth example, and unless contradictory, the description of the fifth example may be applied to the sixth example with respect to matters not described in the sixth example.

The pattern PTN2b will be described. A relationship among times T11 to T17 is as described in the fifth Example. However, the state of the synchronous output terminal S_OUT[i] is inverted between the patterns PTN2a and PTN2b. That is, in the pattern PTN2b, the state of the synchronous output terminal S_OUT[i] is the high level output state at time T11, then switches from the high level output state to the low level output state at time T12, then switches from the low level output state to the high level output state at time T13, then switches from the high level output state to the low level output state at time T15, then switches from the low level output state to the high level output state at time T16, and then is maintained at the high level output state until time T17.

One cycle of the clock signal CLK[i] of the pattern PTN2b corresponds to a period between times T11 and T17. In the pattern PTN2b, in a case where the period between time T11 and T17 is the j-th period of the clock signal CLK[i], a period of time (2×t_{U2}) from time T17 is the (j+1)-th period of the clock signal CLK[i]. In this case, j represents any natural number. The waveform of the clock signal CLK[i] is the same in each cycle of the clock signal CLK[i] of the pattern PTN2b.

In the pattern PTN2a, waveforms WV3 and WV4 appear alternately in the clock signal CLK[i]. When the period between times T11 and T17 is focused on, the waveform WV3 is the waveform of the clock signal CLK[i] between times T11 and T14, and the waveform WV4 is the waveform of the clock signal CLK[i] between times T14 and T17.

As described above, the synchronous output circuit 40[i] alternately sets the state of the synchronous output terminal S_OUT[i] to the low level output state and the high level output state during the output period of the clock signal CLK[i] of the pattern PTN2b and does not set the state of the synchronous output terminal S_OUT[i] to the Hi-Z state. In this case, the unit time t_{U2} may be the same as the unit time t_{U1}, or may be approximately the same as the unit time t_{U1} (see FIG. 21). In this case, it is assumed that “t_{U2}=t_{U1}.”

An operation of the pattern determination circuit 70 according to the sixth example is similar to that of the fifth example. However, when applying the description of the fifth example to the sixth example, the waveform symbols “WV1” and “WV2” in the fifth example are read as “WV3” and “WV4,” respectively, in the sixth example. The pattern symbol “PTN2a” in the fifth example is read as “PTN2b” in the sixth example.

The pattern determination circuit 70[i] determines whether or not the clock signal of the pattern PTN2b is input to the synchronous input terminal S_IN[i], based on the voltage of the synchronous input terminal S_IN[i], and outputs a pattern determination signal S_{PTN}[i] indicating a result of the determination. At this time, the pattern determination circuit 70[i] performs the above-mentioned determination based on the voltage of the synchronous input terminal S_IN[i] at determination times T_{K1} and T_{K2}. In the sixth example, handling of the rising edge and falling edge is reversed in comparison with the fifth example. In other words, in the sixth example, determination time T_{K1} is a time after a predetermined time Δt after the falling edge occurs in the signal of the synchronous input terminal S_IN[i], and determination time T_{K2} is a time after a predetermined time Δt after the next falling edge occurs in the signal of the synchronous input terminal S_IN[i].

When the clock signal CLK[i] of the pattern PTN2b shown in FIG. 29 is output from the device 10[i], it is the device 10[i+1] that receives the clock signal CLK[i] (see FIG. 11). Therefore, when the operation of the pattern determination circuit 70[i+1] in the device 10[i+1] is focused on, the operation of the pattern determination circuit 70[i+1] is as follows.

The pattern determination circuit 70[i+1] determines whether or not the clock signal CLK[i] has the pattern PTN2b by determining whether or not the clock signal CLK[i] has a waveform that switches between the waveforms WV3 and WV4, based on a voltage of the synchronous input terminal S_IN[i+1]. More specifically, when the signal level of the synchronous input terminal S_IN[i+1] changes between a high level and a low level, the pattern determination circuit 70[i+1] extracts two consecutive falling edges in the signal of the synchronous input terminal S_IN[i+1] as first and second falling edges. Then, the pattern determination circuit 70[i+1] specifies a level of the synchronous input terminal S_IN[i+1] at a time after a predetermined time Δt from the first falling edge and a level of the synchronous input terminal S_IN[i+1] at a time after a predetermined time Δt from the second falling edge. The pattern determination circuit 70[i+1] determines that the clock signal of the pattern PTN2b is input to the synchronous input terminal S_IN[i+1] only when one of the two specified levels is a high level and the other is a low level, and outputs the pattern determination signal S_{PTN}[i+1] of “1” and, otherwise, outputs the pattern determination signal S_{PTN}[i] having a value of “0.” One of the time after the predetermined time Δt from the first falling edge and the time after the predetermined time Δt from the second falling edge is determination time T_{K1} and the other is determination time T_{K2}.

The synchronous output circuit 40[i] according to the sixth example can selectively output the clock signal CLK[i] of the pattern PTN2b and the clock signal CLK[i] of the pattern PNT1b shown in FIG. 21.

In a case where the clock signal CLK[i] has the pattern PTN1b, when the synchronous input terminal S_IN[i+1] is set to the pull-up state, after a predetermined time Δt from the falling edge of the signal of the synchronous input terminal S_IN[i+1], since the signal of the synchronous input terminal S_IN[i+1] always has a high level, the pattern determination signal S_{PTN}[i+1] becomes “0.” Similarly, in a case where the clock signal CLK[i] has the pattern PTN1b, when the synchronous input terminal S_IN[i+1] is set to the pull-down state, after a predetermined time Δt from the falling edge of the signal of the synchronous input terminal S_IN[i+1], since the signal of the synchronous input terminal S_IN[i+1] always has a low level, the pattern determination signal S_{PTN}[i+1] becomes “0.”

On the other hand, when the clock signal CLK[i] has the pattern PTN2b, since one of the levels of the synchronous input terminal S_IN[i+1] at the two determination times T_{K1} and T_{K2} is a high level and the other is a low level regardless of the state of the synchronous input terminal S_IN[i+1], the pattern determination signal S_{PTN}[i+1] of “1” is generated. Therefore, the pattern determination signal S_{PTN}[i+1] of “1” indicates that the clock signal CLK[i] input to the synchronous input terminal S_IN[i+1] has the pattern PTN2b.

Similar to the fifth example, it is possible to forcibly perform switching control on all channels by using the clock signal CLK[i] having the pattern PTN2b. The matters described in the fifth example regarding the forced output condition are also applied to the sixth example.

The sixth example can be implemented in combination with the second example, as will be described below. In the sixth example, the second rule described in the second example is adopted, and the set edge is a falling edge. That is, the controller 28 of the device 10[i+1] turns on the transistor MH and turns off the transistor ML in response to the falling edge of the clock signal CLK[i]. Therefore, when applying the description of the fifth example to the sixth example, the “rising edge” in the fifth example may be read as the “falling edge” in the sixth example. Further, in the sixth example combined with the second example, it is preferable to use the synchronous output circuit 40C of FIG. 26 as the synchronous output circuit 40 of each device 10.

When switching control is performed in the device 10[1] in the situation FORCE_ON, the clock management circuit 80[1] controls the synchronous output circuit 40[1] to cause the synchronous output circuit 40[1] to output the clock signal CLK[1] having the pattern PTN2b from the synchronous output terminal S_OUT[1] regardless of whether or not the clock output condition (clock output condition in step S14 in FIG. 24) is satisfied. The clock signal CLK[1] having the pattern PTN2b is generated based on the reference clock signal CLK_{REF} (i.e., the clock signal CLK[0]) of the device 10[1].

When the clock signal CLK[1] having the pattern PTN2b is input to the synchronous input terminal S_IN[2], the clock signal CLK[1] having the pattern PTN2b is input to the controller 28 of the device 10[2], as the reference clock signal CLK_{REF} of the device 10[2]. Therefore, the output stage MM[2] is switched in synchronization with the clock signal CLK[1]. That is, in response to the falling edge of the clock signal CLK[1] having the pattern PTN2b, the transistor MH of the output stage MM[2] is turned on and the transistor ML thereof is turned off.

Further, when the clock signal CLK[1] having the pattern PTN2b is input to the synchronous input terminal S_IN[2], the pattern determination signal S_{PTN}[2] has a value of “1.” When “S_{PTN}[2]=1,” the clock management circuit 80[2] controls the synchronous output circuit 40[2] to cause the synchronous output circuit 40[2] to output the clock signal CLK[2] having the pattern PTN2b from the synchronous output terminal S_OUT[2] regardless of whether or not the clock output condition (the clock output condition in step S24 in FIG. 25) is satisfied. The clock signal CLK[2] having the pattern PTN2b is generated based on the reference clock signal CLK_{REF} of the device 10[2] (i.e., the input clock signal CLK[1] to the device 10[2]).

The operations of other devices 10 (for example, the device 10[3]) operating in the second mode are similar to the operation of the device 10[2]. That is, for example, when the clock signal CLK[2] having the pattern PTN2b is input to the synchronous input terminal S_IN[3], the clock signal CLK[2] having the pattern PTN2b is input to the controller 28 of the device 10[3], as the reference clock signal CLK_{REF} of the device 10[3]. Therefore, the output stage MM[3] is switched in synchronization with the clock signal CLK[2]. That is, in response to the falling edge of the clock signal CLK[2] having the pattern PTN2b, the transistor MH of the output stage MM[3] is turned on and the transistor ML thereof is turned off.

Further, when the clock signal CLK[2] having the pattern PTN2b is input to the synchronous input terminal S_IN[3], the pattern determination signal S_{PTN}[3] has a value of “1.” When “S_{PTN}[3]=1,” the clock management circuit 80[3] controls the synchronous output circuit 40[3] to cause the synchronous output circuit 40[3] to output the clock signal CLK[3] having the pattern PTN2b from the synchronous output terminal S_OUT[3] regardless of whether or not the clock output condition (the clock output condition in step S24 in FIG. 25) is satisfied. The clock signal CLK[3] having the pattern PTN2b is generated based on the reference clock signal CLK_{REF} of the device 10[3] (i.e., the input clock signal CLK[2] to the device 10[3]).

The same applies to the devices 10[4] to 10[n]. Therefore, in the situation FORCE_ON, switching control is performed in the devices 10 of all channels, regardless of whether or not the clock output condition is satisfied.

The operation of the device 10[1] when the forced output condition is not satisfied is the same as that shown in FIG. 24, and the operation of each of the devices 10[2] to 10[n] when the forced output condition is not satisfied is the same as that shown in FIG. 25. However, the clock signal CLK[i] that can be output from the device 10[i] when the forced output condition is not satisfied has the same pattern PTN1b as in the second example. Therefore, in a case where the forced output condition is not satisfied, when the clock signal CLK[1] is not supplied to the synchronous input terminal S_IN[2], the synchronous output circuit 40[2] of the device 10[2] does not output any clock signal (keeps the synchronous output terminal S_OUT [2] in the Hi-Z state). In a case where the forced output condition is not satisfied, when the clock signal CLK[1] of the pattern PTN1b is supplied to the synchronous input terminal S_IN[2], the device 10[2] performs switching control in synchronization with the clock signal CLK[1]. When the clock output condition is satisfied in the device 10[2], the clock signal CLK[2] of the pattern PTN1b based on the clock signal CLK[1] (the input clock signal CLK[1] to the device 10[2]) is output from the synchronous output terminal S_OUT[2] by the synchronous output circuit 40[2]. The same applies to other devices 10 (for example, the device 10[3]) that operate in the second mode.

In the device 10[1] operating in the first mode, when the forced output condition is not satisfied, after the synchronous output circuit 40[1] starts the output of the clock signal CLK[1] of the pattern PTN1b, the output of the clock signal CLK[1] of the pattern PTN1b is stopped in response to the establishment of the clock stop condition (the clock stop condition in step S16a in FIG. 24).

When the forced output condition is not satisfied, the clock signal CLK[1] of the pattern PTN1b may be supplied to the synchronous input terminal S_IN[2]. In the device 10[2] operating in the second mode, when the clock signal CLK[1] of the pattern PTN1b is supplied to the synchronous input terminal S_IN[2], after the synchronous output circuit 40[2] starts the output of the clock signal CLK[2] of the pattern PTN1b, the output of the clock signal CLK[2] of the pattern PTN1b is stopped in response to the establishment of the clock stop condition (clock stop condition in step S26a in FIG. 25). The same applies to other devices 10 (for example, the device 10[3]) that operate in the second mode.

For the sake of convenience, the waveforms of the clock signals CLK[0] to CLK[3] in the 4-channel drive state under the situation FORCE_ON according to the sixth example are referred to as clock signals CLK[0]_{EX6} to CLK[3]_{EX6}. For the sake of convenience, the waveforms of the clock signals CLK[0] to CLK[3] in the 4-channel drive state under the situation FORCE_ON according to the fifth example are referred to as clock signals CLK[0]_{EX5} to CLK[3]_{EX5}. The clock signals CLK[0]_{EX5} to CLK[3]_{EX5} are the clock signals CLK[0] to CLK[3] shown in FIG. 28. In the sixth example, the set edge corresponds to a falling edge, and the clock signal CLK[i]_{EX6} may be an inversion of the clock signal CLK[i]_{EX5} for an integer i from 0 to 3.

### Seventh Example

A seventh example will be described.

In the switching power supply 1 of FIGS. 1 and 3, the device 10[1] operates in the first mode, and the devices 10[2] to 10[n] operate in the second mode. Therefore, the operation of the device 10[1] has been described as the operation of the device 10 in the first mode, and the operations of the devices 10[2] to 10[n] have been described as the operation of the device 10 in the second mode. However, each device 10 may operate in the first mode or the second mode depending on how it is incorporated into the switching power supply 1. That is, each device 10 can realize the operation of the device 10[1] or the operation of any one of the devices 10[2] to 10[n] depending on the operation mode.

Therefore, in one arbitrary device 10[i] of interest (hereinafter, referred to as an interested device 10[i]), the switching control circuit 20[i]
performs switching control of the output stage MM[i] in synchronization with the reference clock signal CLK_{REF} based on the internal clock signal CLK_{A} or based on the input clock signal CLK_{B} when the interested device 10[i] operates in the first mode,
stops the switching control of the output stage MM[i] when the interested device 10[i] operates in the second mode and the input clock signal CLK_{B} is not supplied to the synchronous input terminal S_IN[i], and
performs the switching control of the output stage MM[i] in synchronization with the reference clock signal CLK_{REF} based on the input clock signal CLK_{B} when the interested device 10[i] operates in the second mode and the input clock signal CLK_{B} is supplied to the synchronous input terminal S_IN[i].

Further, for example, in the interested device 10[i] according to the fifth or sixth example, the synchronous output circuit 40[i]
outputs the first pattern (PTN1a or PTN1b) output clock signal CLK[i], which is based on the reference clock signal CLK_{REF}, from the synchronous output terminal S_OUT[i] in response to the establishment of the clock output condition during the execution period of the switching control to the output stage MM[i] when the interested device 10[i] operates in the first mode and the forced output condition is not satisfied,
outputs the second pattern (PTN2a or PTN2b) output clock signal CLK[i], which is based on the reference clock signal CLK_{REF}, from the synchronous output terminal S_OUT[i] regardless of whether or not the clock output condition is satisfied during the execution period of the switching control to the output stage MM[i] when the interested device 10[i] operates in the first mode and the forced output condition is satisfied,
outputs neither the first pattern output clock signal nor the second pattern output clock signal from the synchronous output terminal S_OUT[i] when the interested device 10[i] operates in the second mode and the input clock signal CLKB (CLK[i]) is not supplied to the synchronous input terminal S_IN[i],
outputs the first pattern (PTN1a or PTN1b) output clock signal CLK[i], which is based on the input clock signal CLK_{B} (CLK[i−1]), from the synchronous output terminal S_OUT[i] in response to the establishment of the clock output condition during the execution period of the switching control to the output stage MM[i] when the interested device 10[i] operates in the second mode and the first pattern (PTN1a or PTN1b) input clock signal CLK_{B}(CLK[i−1]) is supplied to the synchronous input terminal S_IN[i], and
outputs the second pattern (PTN2a or PTN2b) output clock signal CLK[i], which is based on the input clock signal CLK_{B}, from the synchronous output terminal S_OUT[i] regardless of whether or not the clock output condition is satisfied during the execution period of the switching control to the output stage MM[i] when the interested device 10[i] operates in the second mode and the second pattern (PTN2a or PTN2b) input clock signal CLK_{B} (CLK[i−1]) is supplied to the synchronous input terminal S_IN[i].

Various other operations are similarly understood.

In the above description, it is assumed that an electronic component including only one device 10 is configured in one housing, but an electronic component including two or more devices 10 may be configured in one housing. That is, for example, when “n=4,” a first electronic component (first semiconductor device) formed by accommodating the devices 10[1] and 10[2] in a common first housing and a second electronic component (second semiconductor device) formed by accommodating the devices 10[3] and 10[4] in another common second housing may be provided in the switching controller 1. Even in this case, when the method of each of the above-described examples is used, information other than the synchronous clock signal can be transmitted between the first and second electronic components by using the terminals S_OUT[2] and S_IN[3].

When switching control is performed by two or more devices 10 in the switching power supply 1, it is not essential to shift the phases of the switching control in the two or more devices 10 from each other. Therefore, for example, in the above-described 4-channel drive state, the phases of the clock signals CLK[0] to CLK[3] may be the same. That is, for example, when the set edge is a rising edge, the rising edges of the clock signals CLK[0] to CLK[3] may occur simultaneously in the 4-channel drive state. Similarly, for example, when the set edge is a falling edge, the falling edges of the clock signals CLK[0] to CLK[3] may occur simultaneously in the 4-channel drive state.

Alternatively, for example, when the set edge is a rising edge, in the 4-channel drive state, the rising edges of the clock signals CLK[0] and CLK[2] may occur simultaneously and the rising edges of the clock signals CLK[1] and CLK[3] may occur simultaneously, and the timing of the rising edge of the clock signal CLK[0] and the timing of the rising edge of the clock signal CLK[1] may be made different from each other. Similarly, for example, when the set edge is a falling edge, in the 4-channel drive state, the falling edges of the clock signals CLK[0] and CLK[2] may occur simultaneously and the falling edges of the clock signals CLK[1] and CLK[3] may occur simultaneously, and the timing of the falling edge of the clock signal CLK[0] and the timing of the falling edge of the clock signal CLK[1] may be made different from each other.

The DC/DC converter of each channel constituting the above-described switching power supply 1 is a step-down type DC/DC converter, but may be a step-up type or step-up/step-down type DC/DC converter.

For any signal or voltage, the relationship between high and low levels may be reversed from that described above, without detracting from the above described features.

Types of channels of field effect transistors (FETs) shown in the respective embodiments are merely examples. Without detracting from the features described above, the type of channel of any FET may be varied between a P-channel type and an N-channel type.

Any of the transistors described above may be any type of transistor as long as it does not cause any inconvenience. For example, any transistor described above as a MOSFET may be replaced with a junction FET, an insulated gate bipolar transistor (IGBT), or a bipolar transistor as long as it does not cause any inconvenience. Any transistor includes a first electrode, a second electrode, and a control electrode. In the FET, one of the first and second electrodes is a drain, the other is a source, and the control electrode is a gate. In the IGBT, one of the first and second electrodes is a collector, the other is an emitter, and the control electrode is a gate. In the bipolar transistor, which does not belong to the IGBT, one of the first and second electrodes is a collector, the other is an emitter, and the control electrode is a base.

The embodiments of the present disclosure can be appropriately modified in various ways within the scope of the technical features in the claims. The above-described embodiments are merely examples of the embodiments of the present disclosure, and meanings of the terms of the present disclosure or configuration requirements are not limited to those described in the above-described embodiments. The specific numerical values shown in the above-described description are merely examples, and it goes without saying that the values can be changed to various numerical values.

### SUPPLEMENTARY NOTES

Supplementary notes will be provided for the present disclosure in which specific configuration examples are shown in the above-described embodiments.

A power supply controller according to one aspect of the present disclosure is a power supply controller (10) that is provided in a switching power supply (1) configured to generate an output voltage (V_{OUT}) from an input voltage (V_{IN}) and has a configuration (first configuration) that it includes: a synchronous input terminal (S_IN); a synchronous output terminal (S_OUT); an output stage (MM) configured to power-convert the input voltage to the output voltage; a switching control circuit (20) configured to power-convert the input voltage to the output voltage by performing switching control of the output stage in synchronization with a reference clock signal (CLK_{REF}); a synchronous output circuit (40) configured to set a state of the synchronous output terminal to any one of a plurality of output states including first, second, and third output states; and a synchronous input circuit (50) configured to set a state of the synchronous input terminal to any one of a plurality of input states including first and second input states, wherein the synchronous output circuit outputs a signal of a first level (low level) from the synchronous output terminal in the first output state (low level output state), outputs a signal of a second level (high level) higher than the first level from the synchronous output terminal in the second output state (high level output state), and sets an output impedance of the synchronous output circuit to be higher in the third output state (Hi-z state) than in the first output state and the second output state, and wherein the synchronous input circuit is capable of pulling down the synchronous input terminal to the first level or pulling up the synchronous input terminal to the second level via a resistor (54), pulls down the synchronous input terminal in the first input state (pull-down state), and pulls up the synchronous input terminal in the second input state (pull-up state).

According to above-described configuration, by connecting a synchronous output terminal of a first power supply controller and a synchronous input terminal of a second power supply controller and switching the state of the synchronous output terminal of the first power supply controller, it is possible to supply a clock signal for synchronization to the synchronous input terminal of the second power supply controller. At this time, a synchronous input circuit of the second power supply controller selectively pulls down or pulls up the synchronous input terminal, such that when the synchronous output terminal of the first power supply controller is in the third output state, it is possible to transmit information from the second power supply controller to the first power supply controller. That is, it is possible to transmit information from the second power supply controller to the first power supply controller by using the synchronous terminals (the synchronous output terminal and the synchronous input terminal) without providing a dedicated terminal for information transmission. By using this information, it is possible to operate the switching power supply appropriately.

The power supply controller of the first configuration 1 may have a configuration (second configuration) that it further includes: a mode setting circuit (30) configured to set an operation mode of the power supply controller to a first mode or a second mode based on given mode setting information, wherein the switching control circuit is configured to: perform the switching control in synchronization with the reference clock signal based on an internal clock signal (CLK_{A}) or an input clock signal (CLK_{B}), which is supplied to the synchronous input terminal from an outside of the power supply controller, in the first mode; stop the switching control when the input clock signal is not supplied to the synchronous input terminal in the second mode; and perform the switching control in synchronization with the reference clock signal based on the input clock signal when the input clock signal is supplied to the synchronous input terminal in the second mode.

When multiple power supply controllers are connected in cascade, a first stage power supply controller can be operated in the first mode, and the other power supply controllers can be operated in the second mode. At this time, it is possible to transmit information from the power supply controller at the rear stage to the power supply controller in the front stage by using the synchronous terminals (the synchronous output terminal and the synchronous input terminal).

The power supply controller of the second configuration may have a configuration (third configuration) that the synchronous output circuit outputs an output clock signal, which is based on the reference clock signal, from the synchronous output terminal in response to establishment of a predetermined clock output condition (for example, Y in S14 in FIG. 17, Y in S24 in FIG. 18) during an execution period of the switching control in the first mode or the second mode, and the synchronous output circuit includes a first period in which the state of the synchronous output terminal is set to the first output state, a second period in which the state of the synchronous output terminal is set to the second output state, and a third period in which the state of the synchronous output terminal is set to the third output state, in each cycle of the output clock signal during an output period (see FIG. 12 or FIG. 21) of the output clock signal.

The power supply controller of the third configuration may have a configuration (fourth configuration) that the synchronous input circuit sets the state of the synchronous input terminal to one (pull-down state/pull-up state) of the first and second input states during the output period of the output clock signal and sets the state of the synchronous input terminal to the other (pull-up state/pull-down state) of the first and second input states during a non-output period of the output clock signal.

The power supply controller of the fourth configuration 1 may have a configuration (fifth configuration) that it further includes: a level detection circuit (60) connected to the synchronous output terminal, wherein when the output clock signal is output by the synchronous output circuit, the level detection circuit detects which one of the first level and the second level a voltage of the synchronous output terminal in the third period belongs to.

Based on the detection result of the level detection circuit, it is possible to receive information from the power supply controller at the rear stage.

The power supply controller of the fifth configuration may have a configuration (sixth configuration) that the synchronous input circuit sets the state of the synchronous input terminal to the first input state (pull-down state) during the output period of the output clock signal and sets the state of the synchronous input terminal to the second input state (pull-up state) during the non-output period of the output clock signal, the synchronous output circuit stops the output of the output clock signal in response to establishment of a predetermined clock stop condition (for example, Y in S16 in FIG. 17, Y in S26 in FIG. 18) after starting the output of the output clock signal, and the clock stop condition includes a condition in which the voltage of the synchronous output terminal in the third period is detected by the level detection circuit as belonging to the second level (high level).

As a result, it is possible to control the stopping of the output clock signal to the power supply controller at the rear stage with an essential condition that the power supply controller at the rear stage stops the output of the output clock signal to the power supply controller at the further rear stage.

The power supply controller of the fifth configuration may have a configuration (seventh configuration) that the synchronous input circuit sets the state of the synchronous input terminal to the second input state (pull-up state) during the output period of the output clock signal and sets the state of the synchronous input terminal to the first input state (pull-down state) during the non-output period of the output clock signal, the synchronous output circuit stops the output of the output clock signal in response to establishment of a predetermined clock stop condition (for example, Y in S16 in FIG. 17, Y in S26 in FIG. 18) after starting the output of the output clock signal, and the clock stop condition includes a condition in which the voltage of the synchronous output terminal in the third period is detected by the level detection circuit as belonging to the first level (high level).

As a result, it is possible to control the stopping of the output clock signal to the power supply controller at the rear stage with an essential condition that the power supply controller at the rear stage stops the output of the output clock signal to the power supply controller at the further rear stage.

The power supply controller of any one of the first to seventh configurations may have a configuration (eighth configuration) that in the third output state, the synchronous output circuit (40C in FIG. 26 or 40B in FIG. 20) outputs the signal of the first level with the output impedance higher than in the first output state or outputs the signal of the second level with the output impedance higher than in the second output state.

As a result, it is possible to prevent the potential of the synchronous output terminal from becoming unstable in the third output state.

The power supply controller (see the fifth Example or the sixth Example) of the second configuration may have a configuration (ninth configuration) that the synchronous output circuit outputs or does not output an output clock signal from the synchronous output terminal, and the synchronous output circuit is configured to: output an output clock signal of a first pattern (PTN1a or PTN1b), which is based on the reference clock signal, from the synchronous output terminal in response to establishment of a predetermined clock output condition during an execution period of the switching control when a predetermined forced output condition is not satisfied in the first mode; output an output clock signal of a second pattern (PTN2a or PTN2b), which is based on the reference clock signal, from the synchronous output terminal regardless of whether or not the clock output condition is satisfied during the execution period of the switching control when the forced output condition is satisfied in the first mode; output neither the output clock signal of the first pattern nor the output clock signal of the second pattern from the synchronous output terminal when the input clock signal is not supplied to the synchronous input terminal in the second mode; output the output clock signal of the first pattern, which is based on the input clock signal, from the synchronous output terminal in response to the establishment of the clock output condition during the execution period of the switching control when the input clock signal is supplied to the synchronous input terminal in the second mode and the input clock signal has the first pattern; and output the output clock signal of the second pattern, which is based on the input clock signal, from the synchronous output terminal regardless of whether or not the clock output condition is satisfied during the execution period of the switching control when the input clock signal is supplied to the synchronous input terminal in the second mode and the input clock signal has the second pattern.

When multiple power supply controllers are connected in cascade, by using the output clock signal of the second pattern, it is possible to force all the power supply controllers to perform switching control.

The power supply controller of the ninth configuration may have a configuration (tenth configuration) that the synchronous output circuit is configured to include a first period in which the state of the synchronous output terminal is set to the first output state, a second period in which the state of the synchronous output terminal is set to the second output state, and a third period in which the state of the synchronous output terminal is set to the third output state, in each cycle of the output clock signal of the first pattern during an output period (see FIG. 12 or FIG. 21) of the output clock signal of the first pattern; and alternately set the state of the synchronous output terminal to the first output state and the second output state during an output period (see FIG. 27 or FIG. 29) of the output clock signal of the second pattern.

The power supply controller (see FIG. 27 or FIG. 29) of the tenth configuration may have a configuration (eleventh configuration) that the synchronous output circuit mixes a period in which the output clock signal has a first waveform (WV1/WV3) and a period in which the output clock signal has a second waveform (WV2/WV4) in the output period of the output clock signal of the second pattern, the power supply controller is provided with a pattern determination circuit (70) connected to the synchronous input terminal, and the pattern determination circuit determines whether or not the input clock signal has the second pattern by determining whether or not the input clock signal has a waveform that switches between the first waveform and the second waveform, based on a voltage of the synchronous input terminal.

The power supply controller of the eleventh configuration may have a configuration (twelfth configuration) that it further includes a level detection circuit (60) connected to the synchronous output terminal, wherein when the output clock signal of the first pattern is output by the synchronous output circuit, the level detection circuit detects which one of the first level or the second level the voltage of the synchronous output terminal in the third period belongs to.

When using the first pattern, it is possible to receive information from the power supply controller at the rear stage based on the detection result of the level detection circuit.

The power supply controller of the twelfth configuration may have a configuration (thirteenth configuration) that the synchronous input circuit sets the state of the synchronous input terminal to the first input state (pull-down state) during a period in which the output clock signal of the first pattern is output by the synchronous output circuit, and sets the state of the synchronous input terminal to the second input state (pull-up state) during a period in which the output of the output clock signal of the first pattern by the synchronous output circuit is stopped, wherein the synchronous output circuit stops the output of the output clock signal of the first pattern in response to establishment of a predetermined clock stop condition (for example, Y in S16 in FIG. 17, Y in S26 in FIG. 18) after starting the output of the output clock signal of the first pattern when the forced output condition is not satisfied in the first mode or after starting the output of the output clock signal of the first pattern when the input clock signal of the first pattern is supplied to the synchronous input terminal in the second mode, and the clock stop condition includes a condition in which the voltage of the synchronous output terminal in the third period is detected by the level detection circuit as belonging to the second level (high level).

As a result, when using the first pattern, it is possible to control the stopping of the output clock signal to the power supply controller at the rear stage with an essential condition that the power supply controller at the rear stage stops the output of the output clock signal to the power supply controller at the further rear stage.

The power supply controller of the twelfth configuration may have a configuration (fourteenth configuration) that the synchronous input circuit sets the state of the synchronous input terminal to the second input state (pull-up state) during a period in which the output clock signal of the first pattern is output by the synchronous output circuit, and sets the state of the synchronous input terminal to the first input state (pull-down state) during a period in which the output of the output clock signal of the first pattern by the synchronous output circuit is stopped, the synchronous output circuit stops the output of the output clock signal of the first pattern in response to establishment of a predetermined clock stop condition (for example, Y in S16 in FIG. 17, Y in S26 in FIG. 18) after starting the output of the output clock signal of the first pattern when the forced output condition is not satisfied in the first mode or after starting the output of the output clock signal of the first pattern when the input clock signal of the first pattern is supplied to the synchronous input terminal in the second mode, and the clock stop condition includes a condition in which the voltage of the synchronous output terminal in the third period is detected by the level detection circuit as belonging to the first level (low level).

As a result, when using the first pattern, it is possible to control the stopping of the output clock signal to the power supply controller at the rear stage with an essential condition that the power supply controller at the rear stage stops the output of the output clock signal to the power supply controller at the further rear stage.

The power supply controller of any one of the ninth to fourteenth configurations may have a configuration (fifteenth configuration) that when outputting the output clock signal of the first pattern, in the third output state, the synchronous output circuit (40C in FIG. 26 or 40B in FIG. 20) outputs the signal of the first level with the output impedance higher than in the first output state or outputs the signal of the second level with the output impedance higher than in the second output state.

As a result, when using the first pattern, it is possible to prevent the potential of the synchronous output terminal from becoming unstable in the third output state.

The power supply controller of any one of the first to fifteenth configurations may have a configuration (sixteenth configuration) that the output stage includes an output element (MH) constituted by a switching element, and a rectifying element (ML) connected to the output element, a coil (L) is connected to a connection node between the output element and the rectifying element, and the output voltage is generated based on a current (IL) flowing through the coil when the output element is switched between turn-on and turn-off in the switching control of the output stage.

The power supply controller of any one of the first to sixteenth configurations may have a configuration (seventeenth configuration) that the synchronous output terminal in the power supply controller is configured to be connected to a synchronous input terminal of another power supply controller provided in the switching power supply.

The power supply controller of any one of the first to sixteenth configurations may have a configuration (eighteenth configuration) that the synchronous input terminal in the power supply controller is configured to be connected to a synchronous output terminal of another power supply controller provided in the switching power supply.

A switching power supply according to another aspect of the present disclosure is a switching power supply device (1) that is configured to generate an output voltage (V_{OUT}) from an input voltage (V_{IN}) and has a configuration (nineteenth configuration) that it includes: first to n-th power supply controllers (10[1] to 10[n]), where n represents an integer of 2 or more, wherein each of the power supply controllers is a power supply controller of any one of the second to seventh configurations and the ninth to fifteenth configurations, wherein a synchronous output terminal (S_OUT[i]) of an i-th power supply controller is connected to a synchronous input terminal (S_IN[i+1]) of an (i+1)-th power supply controller, where i represents a natural number of (n−1) or less, wherein among the first to n-th power supply controllers, the first power supply controller (10[1]) operates in the first mode, and each of the other power supply controllers (10[2] to 10[n]) operates in the second mode, wherein output stages in the first to n-th power supply controllers are first to n-th output stages, and wherein a current is supplied from an application terminal of the input voltage to an application terminal of the output voltage through one or more output stages in which the switching control is performed, among the first to n-th output stages.

According to the above-described configuration, for example, by switching the state of the synchronous output terminal of the first power supply controller, it is possible to supply a clock signal for synchronization to the synchronous input terminal of the second power supply controller. At this time, a synchronous input circuit of the second power supply controller selectively pulls down or pulls up the synchronous input terminal, such that when the synchronous output terminal of the first power supply controller is in the third output state, it is possible to transmit information from the second power supply controller to the first power supply controller. That is, it is possible to transmit information from the second power supply controller to the first power supply controller by using the synchronous terminals (the synchronous output terminal and the synchronous input terminal) without providing a dedicated terminal for information transmission. By using this information, it is possible to operate the switching power supply appropriately.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A power supply controller provided in a switching power supply configured to generate an output voltage from an input voltage, comprising:
a synchronous input terminal;
a synchronous output terminal;
an output stage configured to power-convert the input voltage to the output voltage;
a switching control circuit configured to power-convert the input voltage to the output voltage by performing switching control of the output stage in synchronization with a reference clock signal;
a synchronous output circuit configured to set a state of the synchronous output terminal to any one of a plurality of output states including first, second, and third output states; and
a synchronous input circuit configured to set a state of the synchronous input terminal to any one of a plurality of input states including first and second input states,
wherein the synchronous output circuit outputs a signal of a first level from the synchronous output terminal in the first output state, outputs a signal of a second level higher than the first level from the synchronous output terminal in the second output state, and sets an output impedance of the synchronous output circuit to be higher in the third output state than in the first output state and the second output state, and
wherein the synchronous input circuit is capable of pulling down the synchronous input terminal to the first level or pulling up the synchronous input terminal to the second level via a resistor, pulls down the synchronous input terminal in the first input state, and pulls up the synchronous input terminal in the second input state.

2. The power supply controller of claim 1, further comprising a mode setting circuit configured to set an operation mode of the power supply controller to a first mode or a second mode based on given mode setting information,
wherein the switching control circuit is configured to:
perform the switching control in synchronization with the reference clock signal based on an internal clock signal or an input clock signal, which is supplied to the synchronous input terminal from an outside of the power supply controller, in the first mode;
stop the switching control when the input clock signal is not supplied to the synchronous input terminal in the second mode; and
perform the switching control in synchronization with the reference clock signal based on the input clock signal when the input clock signal is supplied to the synchronous input terminal in the second mode.

3. The power supply controller of claim 2, wherein the synchronous output circuit outputs an output clock signal, which is based on the reference clock signal, from the synchronous output terminal in response to establishment of a predetermined clock output condition during an execution period of the switching control in the first mode or the second mode, and
wherein the synchronous output circuit includes a first period in which the state of the synchronous output terminal is set to the first output state, a second period in which the state of the synchronous output terminal is set to the second output state, and a third period in which the state of the synchronous output terminal is set to the third output state, in each cycle of the output clock signal during an output period of the output clock signal.

4. The power supply controller of claim 3, wherein the synchronous input circuit sets the state of the synchronous input terminal to one of the first and second input states during the output period of the output clock signal and sets the state of the synchronous input terminal to the other of the first and second input states during a non-output period of the output clock signal.

5. The power supply controller of claim 4, further comprising a level detection circuit connected to the synchronous output terminal,
wherein when the output clock signal is output by the synchronous output circuit, the level detection circuit detects which one of the first level and the second level a voltage of the synchronous output terminal in the third period belongs to.

6. The power supply controller of claim 5, wherein the synchronous input circuit sets the state of the synchronous input terminal to the first input state during the output period of the output clock signal and sets the state of the synchronous input terminal to the second input state during the non-output period of the output clock signal,
wherein the synchronous output circuit stops the output of the output clock signal in response to establishment of a predetermined clock stop condition after starting the output of the output clock signal, and
wherein the clock stop condition includes a condition in which the voltage of the synchronous output terminal in the third period is detected by the level detection circuit as belonging to the second level.

7. The power supply controller of claim 5, wherein the synchronous input circuit sets the state of the synchronous input terminal to the second input state during the output period of the output clock signal and sets the state of the synchronous input terminal to the first input state during the non-output period of the output clock signal,
wherein the synchronous output circuit stops the output of the output clock signal in response to establishment of a predetermined clock stop condition after starting the output of the output clock signal, and
wherein the clock stop condition includes a condition in which the voltage of the synchronous output terminal in the third period is detected by the level detection circuit as belonging to the first level.

8. The power supply controller of claim 1, wherein in the third output state, the synchronous output circuit outputs the signal of the first level with the output impedance higher than in the first output state or outputs the signal of the second level with the output impedance higher than in the second output state.

9. The power supply controller of claim 2, wherein the synchronous output circuit outputs or does not output an output clock signal from the synchronous output terminal, and
wherein the synchronous output circuit is configured to:
output an output clock signal of a first pattern, which is based on the reference clock signal, from the synchronous output terminal in response to establishment of a predetermined clock output condition during an execution period of the switching control when a predetermined forced output condition is not satisfied in the first mode;
output an output clock signal of a second pattern, which is based on the reference clock signal, from the synchronous output terminal regardless of whether or not the clock output condition is satisfied during the execution period of the switching control when the forced output condition is satisfied in the first mode;
output neither the output clock signal of the first pattern nor the output clock signal of the second pattern from the synchronous output terminal when the input clock signal is not supplied to the synchronous input terminal in the second mode;
output the output clock signal of the first pattern, which is based on the input clock signal, from the synchronous output terminal in response to the establishment of the clock output condition during the execution period of the switching control when the input clock signal is supplied to the synchronous input terminal in the second mode and the input clock signal has the first pattern; and
output the output clock signal of the second pattern, which is based on the input clock signal, from the synchronous output terminal regardless of whether or not the clock output condition is satisfied during the execution period of the switching control when the input clock signal is supplied to the synchronous input terminal in the second mode and the input clock signal has the second pattern.

10. The power supply controller of claim 9, wherein the synchronous output circuit is configured to:
include a first period in which the state of the synchronous output terminal is set to the first output state, a second period in which the state of the synchronous output terminal is set to the second output state, and a third period in which the state of the synchronous output terminal is set to the third output state, in each cycle of the output clock signal of the first pattern during an output period of the output clock signal of the first pattern; and
alternately set the state of the synchronous output terminal to the first output state and the second output state during an output period of the output clock signal of the second pattern.

11. The power supply controller of claim 10, wherein the synchronous output circuit mixes a period in which the output clock signal has a first waveform and a period in which the output clock signal has a second waveform in the output period of the output clock signal of the second pattern,
wherein the power supply controller is provided with a pattern determination circuit connected to the synchronous input terminal, and
wherein the pattern determination circuit determines whether or not the input clock signal has the second pattern by determining whether or not the input clock signal has a waveform that switches between the first waveform and the second waveform, based on a voltage of the synchronous input terminal.

12. The power supply controller of claim 11, further comprising a level detection circuit connected to the synchronous output terminal,
wherein when the output clock signal of the first pattern is output by the synchronous output circuit, the level detection circuit detects which one of the first level or the second level the voltage of the synchronous output terminal in the third period belongs to.

13. The power supply controller of claim 12, wherein the synchronous input circuit sets the state of the synchronous input terminal to the first input state during a period in which the output clock signal of the first pattern is output by the synchronous output circuit, and sets the state of the synchronous input terminal to the second input state during a period in which the output of the output clock signal of the first pattern by the synchronous output circuit is stopped,
wherein the synchronous output circuit stops the output of the output clock signal of the first pattern in response to establishment of a predetermined clock stop condition after starting the output of the output clock signal of the first pattern when the forced output condition is not satisfied in the first mode or after starting the output of the output clock signal of the first pattern when the input clock signal of the first pattern is supplied to the synchronous input terminal in the second mode, and
wherein the clock stop condition includes a condition in which the voltage of the synchronous output terminal in the third period is detected by the level detection circuit as belonging to the second level.

14. The power supply controller of claim 12, wherein the synchronous input circuit sets the state of the synchronous input terminal to the second input state during a period in which the output clock signal of the first pattern is output by the synchronous output circuit, and sets the state of the synchronous input terminal to the first input state during a period in which the output of the output clock signal of the first pattern by the synchronous output circuit is stopped,
wherein the synchronous output circuit stops the output of the output clock signal of the first pattern in response to establishment of a predetermined clock stop condition after starting the output of the output clock signal of the first pattern when the forced output condition is not satisfied in the first mode or after starting the output of the output clock signal of the first pattern when the input clock signal of the first pattern is supplied to the synchronous input terminal in the second mode, and
wherein the clock stop condition includes a condition in which the voltage of the synchronous output terminal in the third period is detected by the level detection circuit as belonging to the first level.

15. The power supply controller of claim 9, wherein when outputting the output clock signal of the first pattern, in the third output state, the synchronous output circuit outputs the signal of the first level with the output impedance higher than in the first output state or outputs the signal of the second level with the output impedance higher than in the second output state.

16. The power supply controller of claim 1, wherein the output stage includes an output element constituted by a switching element, and a rectifying element connected to the output element, and
wherein a coil is connected to a connection node between the output element and the rectifying element, and the output voltage is generated based on a current flowing through the coil when the output element is switched between turn-on and turn-off in the switching control of the output stage.

17. The power supply controller of claim 1, wherein the synchronous output terminal in the power supply controller is configured to be connected to a synchronous input terminal of another power supply controller provided in the switching power supply.

18. The power supply controller of claim 1, wherein the synchronous input terminal in the power supply controller is configured to be connected to a synchronous output terminal of another power supply controller provided in the switching power supply.

19. A switching power supply configured to generate an output voltage from an input voltage, comprising:
first to n-th power supply controllers, where n represents an integer of 2 or more,
wherein each of the power supply controllers is a power supply controller of claim 2,
wherein a synchronous output terminal of an i-th power supply controller is connected to a synchronous input terminal of an (i+1)-th power supply controller, where i represents a natural number of (n−1) or less,
wherein among the first to n-th power supply controllers, the first power supply controller operates in the first mode, and each of the other power supply controllers operates in the second mode,
wherein output stages in the first to n-th power supply controllers are first to n-th output stages, and
wherein a current is supplied from an application terminal of the input voltage to an application terminal of the output voltage through one or more output stages in which the switching control is performed, among the first to n-th output stages.
